(19) United States
(12) Patent Application Publication
(10) Pub. No.: US 2004/0177373 A1
(43) Pub. Date: Sep. 9, 2004

(54) Graphic data distribution system and a data converter, and a graphic data distribution method

(76) Inventors: Tsuyoshi Kawabe, Tokyo (JP); Hirotada Ueda, Kokubunji (JP); Kazuhito Yaegashi, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/787,434

(22) Filed: Feb. 27, 2004

(30) Foreign Application Priority Data
Feb. 28, 2003 (JP) 2003-053743

(51) Int. Cl. H04N 7/173; H04N 7/16; H04B 1/00; H04B 7/00

(52) U.S. Cl. 725/62; 725/86; 725/87; 725/134

(57) ABSTRACT

A system and method capable of storing and accumulating video images of targets at places that can not be shot by a monitoring camera and distributing the accumulated video images to one or more devices are provided. A mobile having an image pickup function with a camera unit is connected to a video storage/distribution device through a network. Video data generated by the image pickup mobile is accumulated in the video storage/distribution device to be distributed to a browser PC and a mobile. A data converter for converting the protocol and data format of the video data is provided between the image pickup mobile and the video storage/distribution device, while an authentication server for permitting prescribed mobile to communicate with the video storage/distribution device is provided. Communication of audio data is realized among the image pickup mobile, the browser PC and the mobile.

### BACKGROUND OF THE INVENTION

The present invention relates to a technique for storing a video data picked up by an image pick-up device attached to a mobile (for example, Personal Digital Assistant (PDA)).

In recent years, monitoring systems for watching out for an intruder, a trespasser, etc. by use of a monitoring camera have become widespread, and techniques for distributing video image obtained by the monitoring camera to one or more devices through a network (Internet, LAN, etc.), storing the video image in a storage device/medium (HDD (Hard Disk Drive), DVD (Digital Versatile Disc), etc) as digital data, and displaying the video image distributed by the video image distributing technique on the screen of a mobile are being developed for use in the monitoring system.

Such techniques have been disclosed in, for example, JP-A-2002-24330 and JP-A-2003-6277.

### SUMMARY OF THE INVENTION

In the above conventional techniques, targets (scenes, objects, individuals, etc.) that can be shot by the monitoring camera are limited to those at prescribed positions since fixed camera having substantially fixed and limited shooting angle are used as the monitoring camera. Thus, at places where no monitoring camera is installed, a target at dead angle (blind spot) of monitoring camera can not be shot, and as a matter of course, no video data of the target can be accumulated. The monitoring camera may be equipped on a swivel base but an obstacle etc. may block a part of field of view of the monitoring camera.

It is therefore the primary object of the present invention to provide a video data distribution system capable of accumulating video data of a target at a place that can not be covered by monitoring camera and distributing the accumulated video data to one or more devices.

In order to resolve the above problem, in the present invention, a mobile (or a mobile terminal) having an image pickup function is basically used for shooting the target and video data generated by the image pickup mobile (with an image pick-up device (hereinafter referred to as a camera)) are accumulated in a video storage/distribution device to be distributed to a terminal such as a mobile terminal and a browser PC. The format of the video data generated by the image pickup mobile is converted to a video data format that can be stored in the video storage/distribution device. Further, a terminal transmitting the video data to the video storage/distribution device or receiving the accumulated video data are limited to a prescribed terminal by providing an authentication server to the system. Preferably, audio data are also communicated between the image pickup mobile and the terminal receiving the video data (a mobile terminal, a browser PC, etc.).

In accordance with an aspect of the present invention, a video data distribution system for distributing video data through a network comprises: a video storage/distribution device for storing and distributing video data; a data converter for converting the format of video data generated by an image pickup mobile into a video data format that can be stored in the video storage/distribution device while converting the stored video data into data of a protocol that can be received by a mobile terminal or a terminal connected to the network; and an authentication server for authenticating a mobile terminal (a transmitting mobile terminal) for permitting transmission of data from the prescribed (authorized) mobile terminal only. Video data transmitted from the image pickup mobile (as the transmitting mobile terminal) is stored and accumulated in the video storage/distribution device so that the stored video data can be distributed to a mobile or a terminal connected to the network in response to a request from the mobile or terminal.

In accordance with another aspect of the present invention, there is provided a data converter to be employed for a video data distribution system storing video data in a video storage/distribution device and distributing the video data. The data converter is configured to convert the format of video data generated by an image pickup mobile into a video data format that can be stored in the video storage/distribution device while converting the stored video data into data of a protocol that can be received by a terminal (receiving terminal) to which the data is distributed. The data converter may also be configured to authenticate the receiving terminal in order to distribute data to prescribed (authorized) terminal only.

In accordance with another aspect of the present invention, there is provided a video data distribution method for distributing video data through a network. In the video data distribution method, video data transmitted from a mobile is stored and the stored video data is distributed to a terminal in response to a request from the terminal, by the steps of: authenticating a mobile that transmits data; receiving video data transmitted from the mobile through the network; converting the format of the received video data into a format that can be stored; storing the converted video data; receiving a video data request signal from a terminal requesting the stored video data; authenticating the requesting terminal (data receiving terminal); converting the stored video data requested by the requesting terminal into video data that can be received by the requesting terminal; and transmitting the converted video data to the requesting terminal through the network.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing the structure of a networked monitoring system (network) as a video data distribution system in accordance with a first embodiment of the present invention;

FIGS. 2A and 2B are flow charts showing a method for storing video data obtained by an image pickup mobile of the video data distribution system in a video storage/distribution device;

FIG. 3 is a flow chart showing the details of step S202 of FIG. 2A for establishing connection between the image pickup mobile and the video storage/distribution device through a video storage data converter;

FIG. 4 is a flow chart showing the details of step S203 of FIG. 2A for transmitting video data generated by the image pickup mobile to the video storage/distribution device and storing the video data therein;

FIG. 5 is a flow chart showing the details of step S204 of FIG. 2A for disconnecting the connection between the image pickup mobile and the video storage/distribution device;

FIG. 6 is a block diagram showing an example of the structure of a network in accordance with the embodiment realizing the communication of audio data and data flow in the network;

FIG. 7 is a flow chart explaining a case where audio data is transmitted from a browser PC to an image pickup mobile;

FIG. 8 is a flow chart explaining a case where audio data is transmitted from an image pickup mobile to a browser PC;

FIG. 9 is a block diagram showing an example of system configuration of an emergency medical care system employing video storage techniques and voice communication techniques of the embodiment;

FIG. 10 is a block diagram showing the structure of a networked monitoring system (network) as a video data distribution system in accordance with a second embodiment of the present invention;

FIG. 11 is a block diagram showing an example of hardware configuration of a portable monitoring camera employed in the system of the second embodiment;

FIG. 12 is a flow chart showing a process for storing video data in the video storage/distribution device of the system of FIG. 10;

FIGS. 13A-13C are flow charts showing a process for distributing audio data of sound picked up by the portable monitoring camera to the browser PC, mobile and image pickup mobile;

FIGS. 14A-14C are flow charts showing a process for transmitting audio data of sound picked up by a browser PC, mobile or image pickup mobile to a portable monitoring camera and playing back the audio data by the terminal portable monitoring camera;

FIG. 15 is a block diagram showing an example of application of the networked monitoring system of the second embodiment to a fire department;

FIG. 16 is a block diagram showing an example of application of the networked monitoring system of the second embodiment to a police station;

FIG. 17 is a block diagram showing the structure of a networked monitoring system that can be employed for building up video data distribution systems in accordance with the present invention;

FIG. 18 is a block diagram showing an example of hardware configuration of the video storage/distribution device, etc. of the system of FIG. 17;

FIG. 19 is a flow chart showing a process for storing video data of video images shot by a monitoring camera in the video storage/distribution device;

FIGS. 20A and 20B are flow charts showing a process for viewing the video data stored in the video storage/distribution device by use of a browser PC or mobile; and

FIG. 21 is a table showing an example of a username/password table which is used by an authentication server for user authentication.

### DESCRIPTION OF THE EMBODIMENTS

Referring now to the drawings, a description will be given in detail of preferred embodiments in accordance with the present invention.

FIG. 17 is a block diagram showing the structure of a networked monitoring system (built up around a storage/distribution device) that can be employed for constructing video data distribution systems in accordance with the present invention. The networked monitoring system of FIG. 17 includes a monitoring camera 1001, a Web encoder 1003, a video storage/distribution device 1005, a hub 1004, a browser PC 1006, a video viewing data converter 1007, and a mobile 1011 (PDA, cellular phone, etc.) which are used for viewing video images. The image pickup mobile 101 may be a mobile equipment including at least a mobile terminal with an image pickup function. The reference numeral “1002” denotes transmission lines of a LAN (Local Area Network), “1008” denotes a transmission line of a public circuit, “1009” denotes a WAN (Wide Area Network) 1009 such as the Internet, and “1010” denotes radio transmission links 1010. The monitoring camera 1001, Web encoder 1003, video storage/distribution device 1005, browser PC 1006 and video viewing data converter 1007 are connected together by the hub 1004 and the LAN transmission lines 1002. The video viewing data converter 1007 is connected to the mobile 1011 through the public circuit transmission line 1008, the WAN 1009, and the radio transmission links 1010.

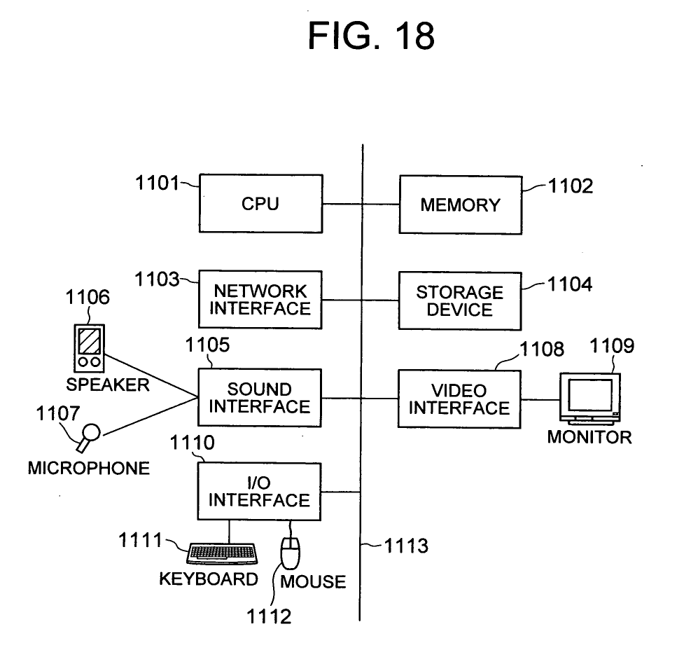

FIG. 18 is a block diagram schematically showing an example of hardware configuration of the video storage/distribution device 1005 of the system of FIG. 17. Incidentally, other network elements (browser PC 1006, video viewing data converter 1007, mobile 1011) can also be implemented by use of components basically equivalent or corresponding to those shown in FIG. 18, and thus such components will also be referred to using the same names and reference numerals. The video storage/distribution device 1005 shown in FIG. 18 includes a CPU (Central Processing Unit) 1101, a memory 1102, a network interface 1103, a storage device 1104, a sound I/O (input-output) interface 1105, a speaker 1106, a microphone 1107, a video interface 1108, a monitor 1109, an I/O interface 1110, an input device 1111 such as a keyboard, a pointing device 1112 such as a mouse, and a bus 1113. The CPU 1101, memory 1102, network interface 1103, storage device 1104, sound I/O interface 1105, video interface 1108 and I/O interface 1110 are connected together by the bus 1113. The speaker 1106 and the microphone 1107 are connected to the sound interface 1105. The monitor 1109 is connected to the video interface 1108. The input device 1111 and the pointing device 1112 are connected to the I/O interface 1110. Although not shown in FIG. 18, the network interface 1103 is connected to the LAN transmission line 1002, the public circuit transmission line 1008 or the radio transmission link 1010 as needed. Incidentally, the configuration shown in FIG. 18 may be different according to a system requirement.

Next, a method for storing video images obtained by the monitoring camera 1001 in the video storage/distribution device 1005 of the system of FIG. 17 will be described. Each monitoring camera 1001 is a fixed camera set at an appropriate point. A video signal containing video images shot by the monitoring camera 1001 is sent to the Web encoder 1003. The Web encoder 1003 converts the analog video signal into a digital video signal of an image data format (JPEG, MPEG, etc.) and transmits the converted video signal to the video storage/distribution device 1005. In the video storage/distribution device 1005, the video signal received by the network interface 1103 is inputted to the CPU 1101. The CPU 1101 assigns an ID number to the video signal and then properly stores the video signal with the ID number in the storage device 1104 as video data.

Next, a method for distributing the video data stored in the video storage/distribution device 1005 to the browser PC 1006 and the mobile 1011 will be described.

Each browser PC 1006 or mobile 1011 sends a video data request signal to the video storage/distribution device 1005. The video data request signal is a signal for requesting a video signal containing desired video data by designating the ID number that was assigned to the video data when it was stored in the storage device 1104 of the video storage/distribution device 1005. For example, the video data request signal transmitted by a browser PC 1006 is transferred by the LAN transmission lines 1002 and the hub 1004 and reaches the video storage/distribution device 1005. The video storage/distribution device 1005 reads the video data having the ID number designated by the video data request signal from the storage device 1104 and transmits a video signal containing the video data to the browser PC 1006. The video signal transmitted by the video storage/distribution device 1005 reaches the browser PC 1006 through the LAN transmission lines 1002 and the hub 1004. The browser PC 1006 which received the video signal converts the video signal into an analog video signal, inputs the converted video signal to the monitor 1109 through the video interface 1108, and thereby displays video images according to the video signal.

Meanwhile, when a similar video data request signal is transmitted by a mobile 1011, the video data request signal is first transferred to the video viewing data converter 1007 through the radio transmission link 1010, the WAN 1009 and the public circuit transmission line 1008. The video viewing data converter 1007 which received the video data request signal converts it into a signal of a protocol suitable for the video storage/distribution device 1005 and transmits the converted video data request signal to the video storage/distribution device 1005. The video storage/distribution device 1005 which received the video data request signal reads proper video data (corresponding to the ID number designated by the video data request signal) from the storage device 1104 and transmits a video signal containing the video data to the video viewing data converter 1007. The video viewing data converter 1007 which received the video signal converts it into a video signal of a suitable format that can be used by the mobile 1011 for displaying the video images on its monitor 1109. Further, the video viewing data converter 1007 selects a protocol suitable for the transmission to the mobile 1011 and converts the video signal into a signal of the selected protocol. Therefore, the video viewing data converter 1007 is a converter having both a protocol conversion function and a video data format conversion function between the video storage/distribution device 1005 and the mobile 1011. The mobile 1011 which received the video signal converts the video signal into an analog signal and displays video images on the monitor 1109 by the analog video signal. Each browser PC 1006 or mobile 1011 can receive either the latest video data stored in the video storage/distribution device 1005 or video data previously accumulated in the video storage/distribution device 1005.

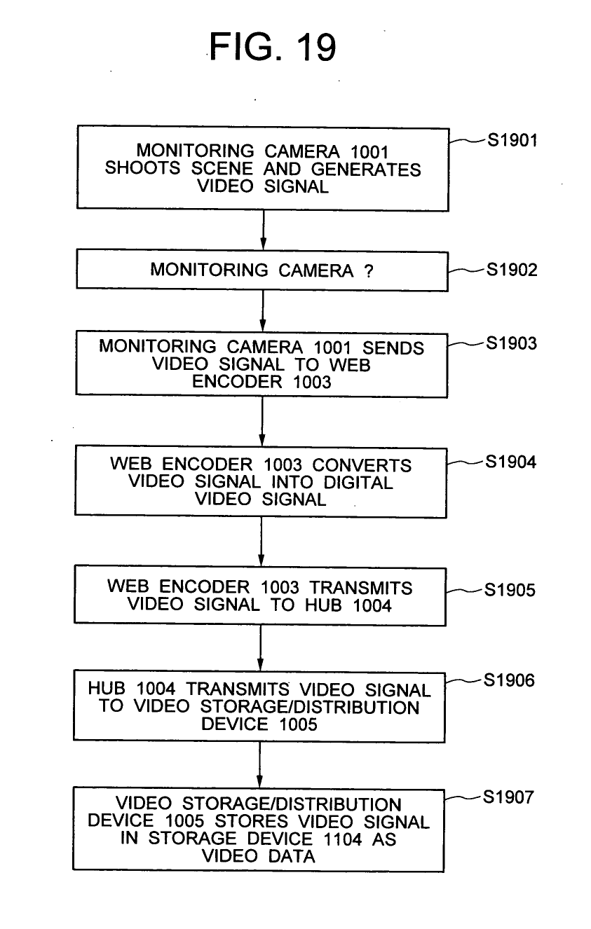

FIG. 19 is a flow chart showing a process for storing video images shot by the monitoring camera 1001 in the video storage/distribution device 1005.

In step S1901, the monitoring camera 1001 shoots the scene in front of the camera and thereby generates a video signal containing video images of the scene. After the step S1901, the device used in the step S1901 may be checked. In this case, if a monitoring camera 1001 was used for shooting in the step S1901, the process proceeds to the next step S1902, otherwise the process may be ended or connection of a monitoring camera 1001 may be waited for. In step S1902, the monitoring camera 1001 sends the video signal to the Web encoder 1003. In step S1903, the Web encoder 1003 converts the video signal into a digital video signal. In steps 1904 and 1905, the Web encoder 1003 transmits the video signal to the video storage/distribution device 1005 through the hub 1004. In step S1906, the video storage/distribution device 1005 stores the video signal in its storage device 1104.

By the above process, the video signal containing the video images of the scene shot by the monitoring camera 1001 is stored in the video storage/distribution device 1005 as the video data.

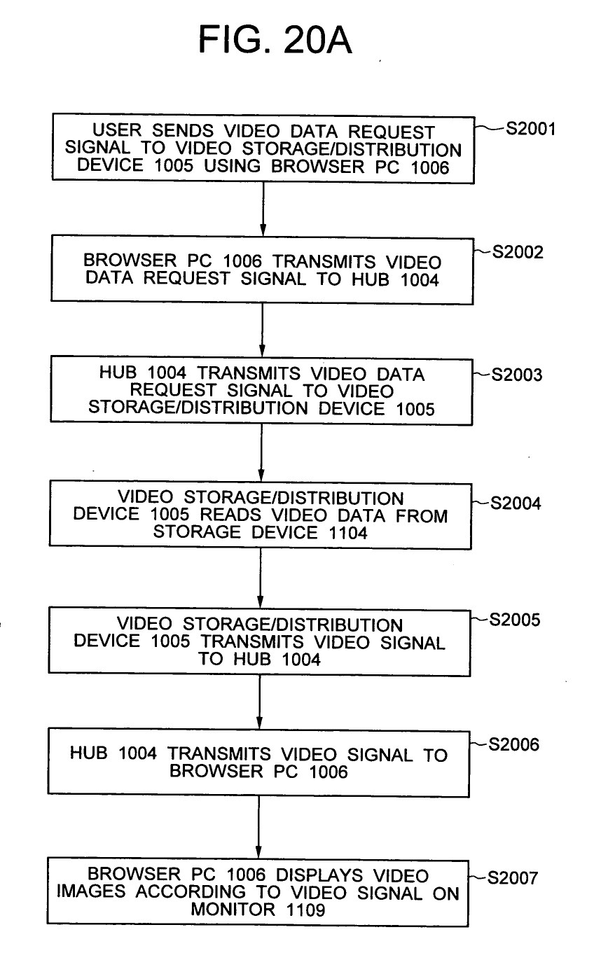

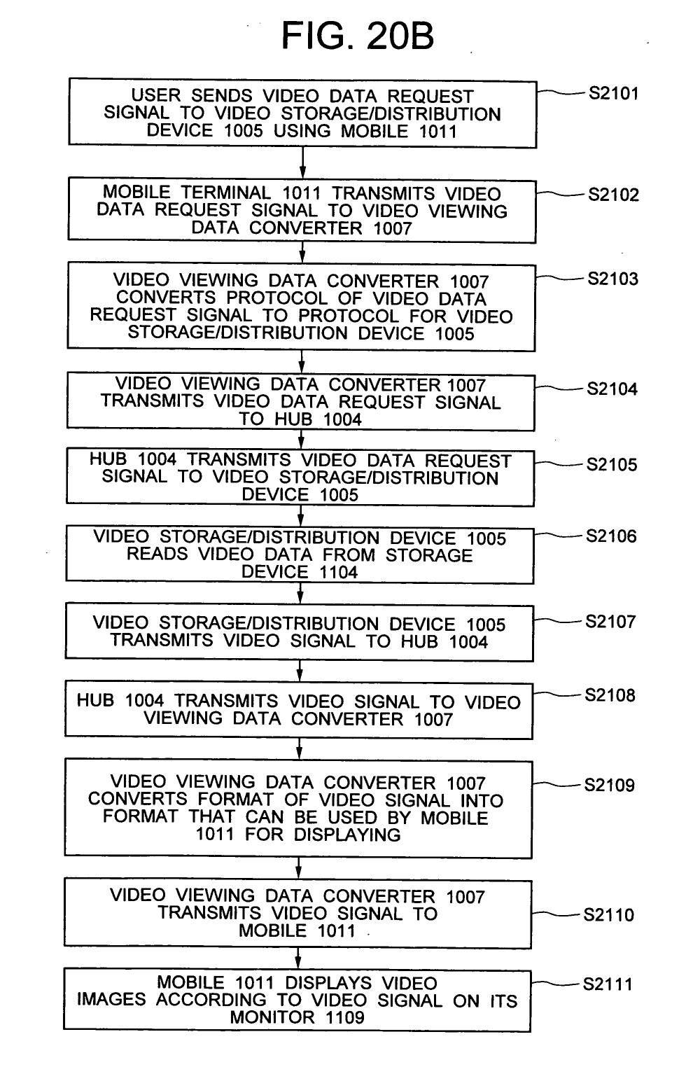

FIGS. 20A and 20B are flow charts explaining a process for viewing the video data stored in the video storage/distribution device 1005 by use of the browser PC 1006 or mobile 1011.

The flow chart shown in FIG. 20A is explained as follows:

In step S2001, the video data request signal is transmitted to the video storage/distribution device 1005 by use of the browser PC 1006. In steps S2002 and S2003, the browser PC 1006 transmits the video data request signal to the video storage/distribution device 1005 through the hub 1004. The video storage/distribution device 1005 reads proper video data from its storage device 1104 according to the video data request signal (step S2004) and transmits a video signal containing the video data to the browser PC 1006 through the hub 1004 (steps S2005 and S2006). The browser PC 1006 which received the video signal displays video images according to the video signal on its monitor 1109 (step S2007).

Meanwhile, FIG. 20B shows a flowchart in the case where the device is a mobile 1011, in step S2101, the video data request signal is transmitted to the video storage/distribution device 1005 by use of the mobile 1011. The process from the step S2102 is carried out. In the step S2102, the mobile 1011 transmits the video data request signal to the video viewing data converter 1007. The video viewing data converter 1007 converts the protocol of the video data request signal to a protocol that can be interpreted by the video storage/distribution device 1005 (step S2103) and transmits the converted video data request signal to the video storage/distribution device 1005 through the hub 1004 (steps S2104 and S2105). The video storage/distribution device 1005 reads proper video data from its storage device 1104 according to the video data request signal (step S2106) and transmits a video signal containing the video data to the video viewing data converter 1007 through the hub 1004 (steps S2107 and S2108). The video viewing data converter 1007 converts the format of the video signal into the format that can be used by the mobile 1011 for the displaying on its monitor 1109 (step S2109) and transmits the video signal to the mobile 1011 (step S2110). The mobile 1011 which received the video signal displays video images according to the video signal on its monitor 1109 (step S2111).

By the above process, the user of a browser PC 1006 or mobile 1011 can view the video images of the video data which have been stored and accumulated in the video storage/distribution device 1005. The video viewing data converter 1007 is also capable of communicating audio signals, by which communication of audio signals between the browser PC 1006 and the mobile 1011 is realized.

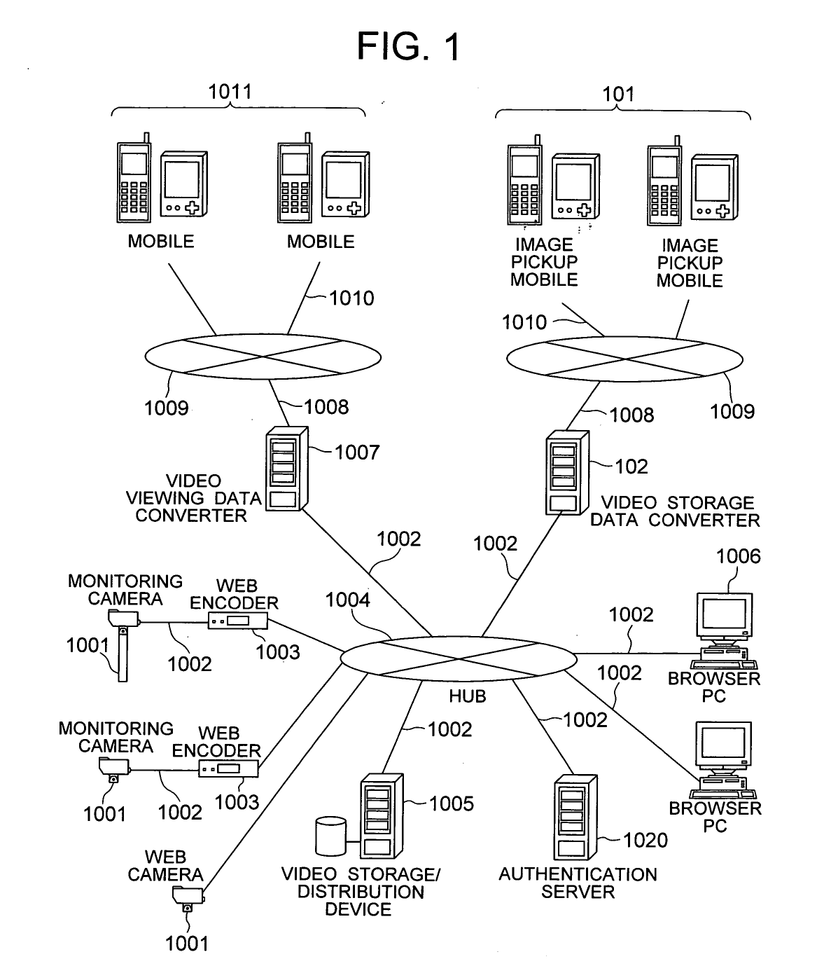

In the following, a networked monitoring system (network) as a video data distribution system in accordance with a first embodiment of the present invention will be described referring to FIGS. 1 through 9.

In this embodiment, video images shot by a mobile having an image pickup function or camera function are stored and accumulated in a storage/distribution device, and the accumulated video images are distributed to a browser PC or a mobile.

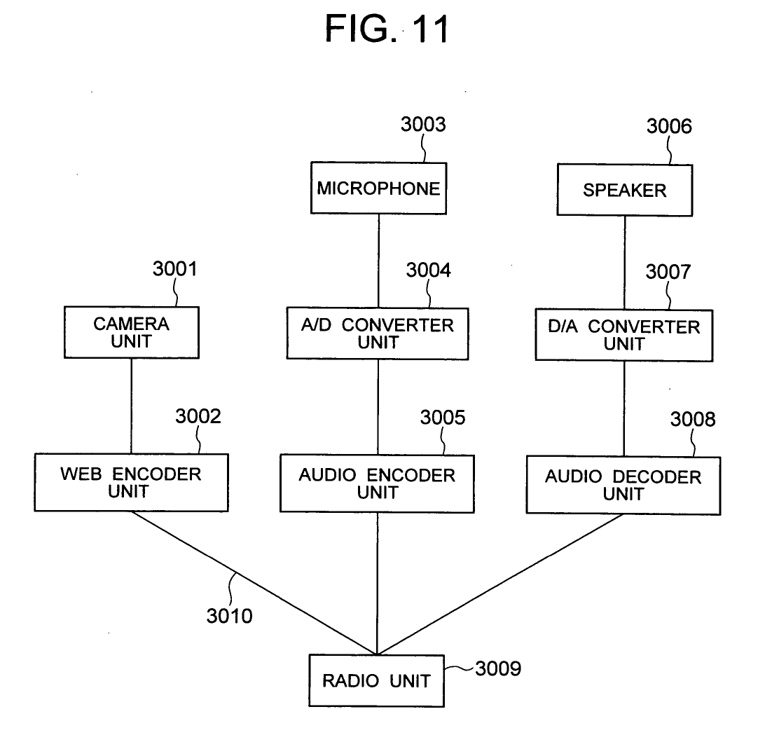

FIG. 1 is a block diagram showing the structure of the network as the video data distribution system in accordance with the first embodiment of the present invention. The network of FIG. 1 further includes a mobile 101 (PDA, cellular phone, etc.) having the image pickup function (hereinafter referred to as “image pickup mobile 101”), a video storage data converter 102 and an authentication server 1020 in comparison with the network of FIG. 17. The image pickup mobile 101 are connected to the video storage data converter 102 through radio transmission links 1010, a WAN 1009 and a public circuit 1008. The image pickup mobile 101 and the video storage data converter 102 are implemented by computers having hardware configurations like that shown in FIG. 11.

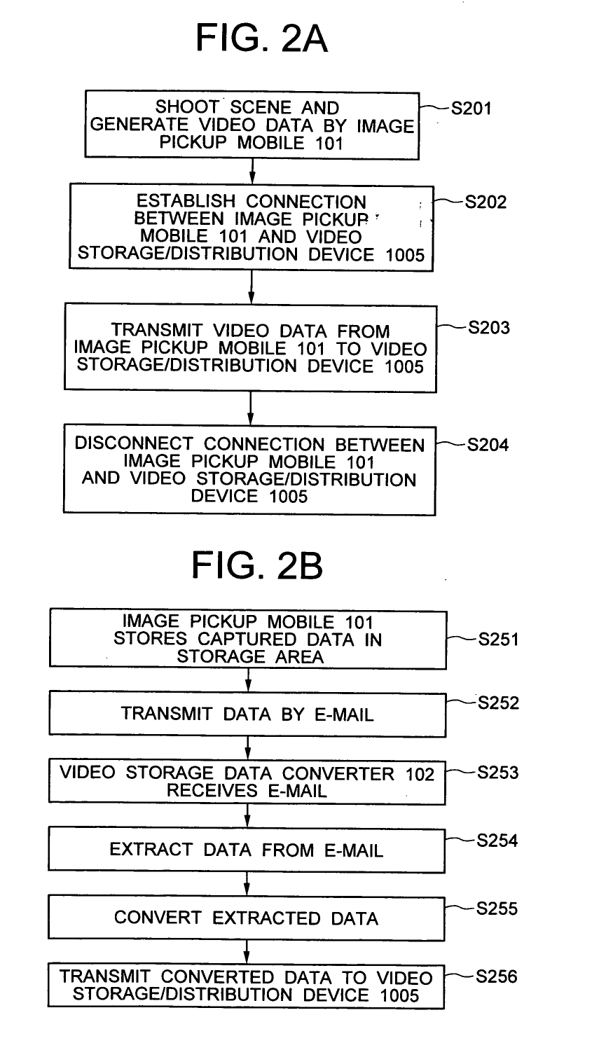

FIG. 2A is a flow chart showing an example of a process for storing a video signal containing video images shot by the image pickup mobile 101 shown in FIG. 1 in the video storage/distribution device 1005 through the video storage data converter 102.

In step S201, the user of the image pickup mobile 101 shoots a scene with the camera (realizing the image pickup function) of the image pickup mobile 101 and a video signal containing video data of the scene is generated by the image pickup mobile 101. In step S202, communication (connection) between the image pickup mobile 101 and the video storage/distribution device 1005 is established. In this step, an authentication process for authenticating the image pickup mobile 101 is also carried out by the authentication server 1020 in order to judge whether or not the image pickup mobile 101 has been authorized to communicate with the video storage/distribution device 1005. In step S203, the image pickup mobile 101 transmits the video signal to the video storage/distribution device 1005. In step S204, the connection between the image pickup mobile 101 and the video storage/distribution device 1005 is disconnected. Incidentally, the establishment of the connection between the image pickup mobile 101 and the video storage/distribution device 1005 (step S202) may also be done before the video data is generated by the image pickup mobile 101 (step S201), that is, either of the steps S201 and S202 may be executed prior to the other.

FIG. 2B is a flow chart showing a method for transmitting the video data of the video images shot by the camera of the image pickup mobile 101 (PDA, cellular phone, etc.) to the video storage/distribution device 1005.

Video data or still image data obtained by shooting a scene with the camera is stored in a storage area (memory, etc.) of the image pickup mobile 101 as a file (step S251). The file stored in the storage area is transmitted to the video storage data converter 102 (having an e-mail server function) as an attached file of an e-mail by a built-in e-mail function of the image pickup mobile 101 using an e-mail communication protocol (step S252). The transmitted e-mail is received by the video storage data converter 102 by its e-mail server function (e.g. POP server function) (step S253). The attached file of the e-mail is extracted from the e-mail by a program stored in a magnetic recording device of the video storage data converter 102 (step S254). Data is read out from the extracted attached file, codec conversion and format conversion are executed to the data as needed, and the data is stored in a storage area of the video storage data converter 102. In this step, the codec conversion and format conversion are carried out so that the codec and format will become those that are used when the monitoring camera 1001 transmit video images to the video storage/distribution device 1005 (step S255). The data stored in the storage area of the video storage data converter 102 is transmitted to the video storage/distribution device 1005 using the same communications protocol. (e.g. HTTP) as that used when the monitoring camera 1001 transmit video images to the video storage/distribution device 1005 (step S256). The transmitted data is received by the video storage/distribution device 1005 and stored in its storage device 1104. The codec may include JPEG, MPEG1, MPEG2, MPEG4, H.261, H.323, etc. The format basically contains codec/header information.

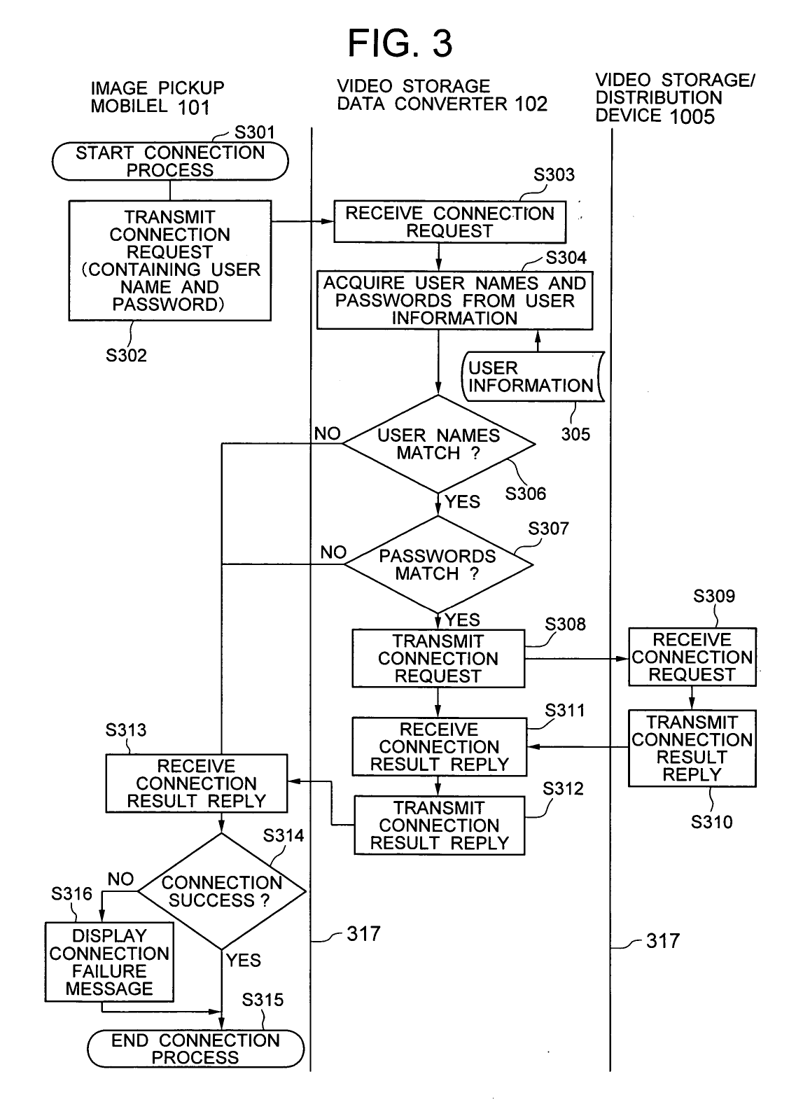

FIG. 3 is a flow chart showing the details of the step S202 of FIG. 2A for establishing the connection between the image pickup mobile 101 and the video storage/distribution device 1005 through the video storage data converter 102.

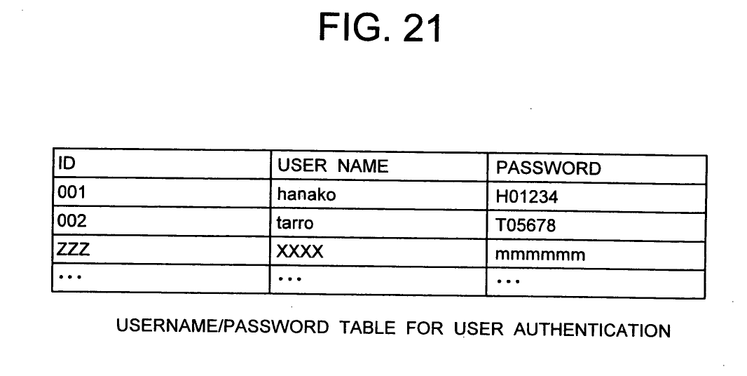

The user previously makes access to a user authentication server (authentication server 1020) from a browser PC 1006 and inputs a user name and a password in a table shown in FIG. 21 as user information stored in a storage area of the user authentication server. In step S301, the process for establishing connection between the image pickup mobile 101 and the video storage/distribution device 1005 is started. In step S302, the image pickup mobile 101 transmits a connection request signal to the video storage data converter 102. The connection request signal contains the user name and password of the user. The user name and password of the user of the image pickup mobile 101 have previously been registered with the video storage data converter 102 by the user. In step S303, the video storage data converter 102 receives the connection request signal. In step S304, the video storage data converter 102 acquires user names and passwords from “user information 305”. The user information 305 is a file stored in the storage device 1104 of the video storage data converter 102 for storing user names and passwords previously registered with the video storage data converter 102 by users of the image pickup mobile 101. In step S306, the user name contained in the connection request signal received in the step S303 is compared with the user names acquired from the user information 305 in the step S304. If the user name in the connection request signal matches none of the user names acquired from the user information 305 (S306: NO), the video storage data converter 102 judges that the user transmitting the connection request signal is an unauthorized user and thereby proceeds to step S313. If the user names match (S306: YES), the process proceeds to the next step S307, in which the password included in the connection request signal received in the step S303 is compared with the password (corresponding to the user name) acquired from the user information 305 in the step S304. If the passwords do not match (S307: NO), the video storage data converter 102 judges that the user transmitting the connection request signal is an unauthorized user and thereby proceeds to step S313. If the passwords match (S307: YES), the process proceeds to the next step S308, in which the video storage data converter 102 transmits a connection request signal to the video storage/distribution device 1005. In step S309, the video storage/distribution device 1005 receives the connection request signal from the video storage data converter 102. In step S310, the video storage/distribution device 1005 transmits a connection result reply signal (indicating whether or not the connection has been established successfully for the connection request signal) to the video storage data converter 102. In step S311, the video storage data converter 102 receives the connection result reply signal of the step S310. In step S312, the video storage data converter 102 converts the protocol of the connection result reply signal to a proper protocol (that can be interpreted by the image pickup mobile 101) and transmits the converted connection result reply signal to the image pickup mobile 101. In step S313, the image pickup mobile 101 receives the connection result reply signal transmitted from the video storage data converter 102. In step S314, the image pickup mobile 101 interprets the connection request signal and judges the result of the connection establishment. If the connection is judged to have succeeded (S314: YES), the process proceeds to the next step S315, otherwise (S314: NO) the process proceeds to step S316. In the step S315, the connection process is ended normally with the successful connection establishment between the image pickup mobile 101 and the video storage/distribution device 1005. On the other hand, in the step S316, the user of the image pickup mobile 101 is informed of the failure of the connection process by a connection failure message displayed on the monitor of the image pickup mobile 101.

Incidentally, the lines 317 drawn in FIG. 3 indicate boundaries separating the image pickup mobile 101, the video storage data converter 102 and the video storage/distribution device 1005.

The above connection process may also be conducted in cooperation with the electronic authentication service (digital certificate service) “FirstPass” employing PKI (Public Key Infrastructure) which is provided by NTT DoCoMo, Inc. for FOMA cellular phones. The “FirstPass”, considering users forgetting their IDs or passwords, allows the users to log in by key entry of only one code (PIN2). In this case, the user authentication server has a function for verifying that a user certificate has been issued by NTT DoCoMo, Inc. or a company in the DoCoMo group and a function for verifying an ID number (different from the telephone number) that have been assigned by NTT DoCoMo, Inc. or the DoCoMo group to the user for each FOMA service contract.

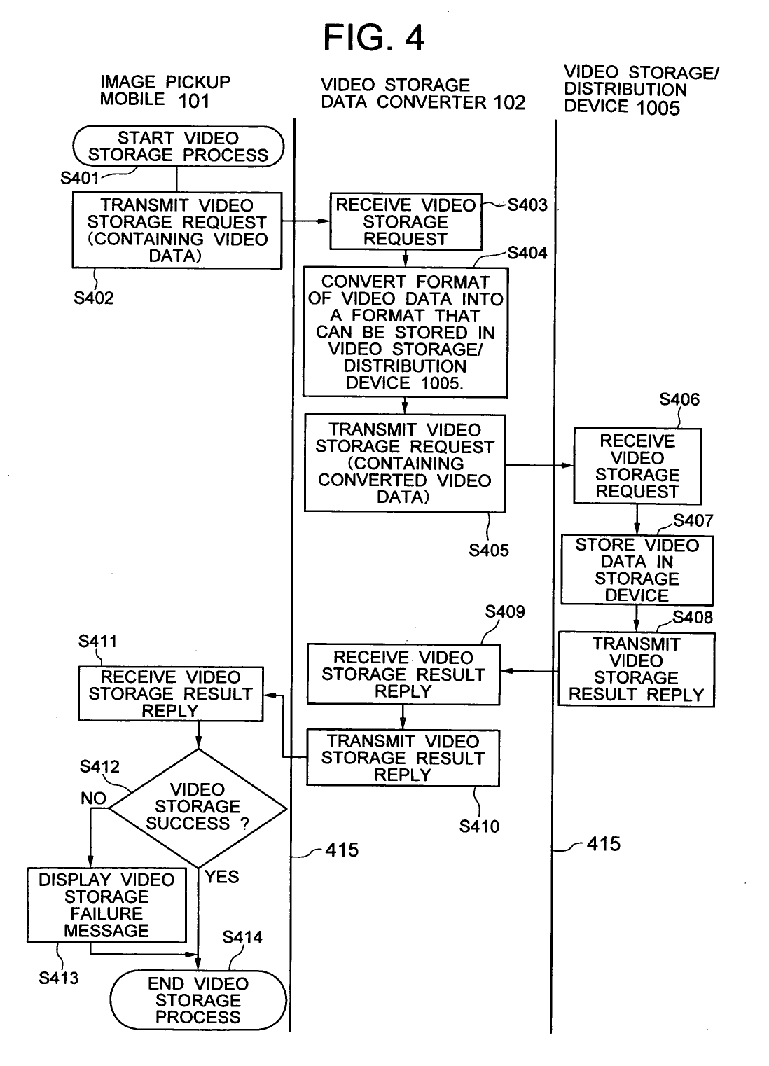

FIG. 4 is a flow chart showing the details of the step S203 of FIG. 2A for transmitting the video signal containing the video data generated by the image pickup mobile 101 to the video storage/distribution device 1005 through the video storage data converter 102 and storing the video data in the video storage/distribution device 1005.

In step S401, the video storage process is started. In step S402, the image pickup mobile 101 transmits a video storage request signal to the video storage data converter 102. The video storage request signal contains the video data generated in the step S201. In step S403, the video storage data converter 102 receives the video storage request signal. In step S404, the video storage data converter 102 extracts the video data from the video storage request signal and converts (codec conversion) the format of the extracted video data into a format that can be stored in the video storage/distribution device 1005. In step S405, the video storage data converter 102 transmits the video storage request signal to the video storage/distribution device 1005 using a protocol that can be interpreted by the video storage/distribution device 1005. The video storage request signal includes the video data converted in the step S404. In step S406, the video storage/distribution device 1005 receives the video storage request signal. In step S407, the video storage/distribution device 1005 extracts the video data from the video storage request signal and stores the extracted video data in its storage device 1104. In step S408, the video storage/distribution device 1005 transmits a video storage result reply signal (indicating whether or not the video storage process by the video storage/distribution device 1005 ended normally) to the video storage data converter 102. In step S409, the video storage data converter 102 receives the video storage result reply signal transmitted in the step S408. In step S410, the video storage data converter 102 converts the protocol of the video storage result reply signal into a protocol that can be interpreted by the image pickup mobile 101 and transmits the converted video storage result reply signal. In step S411, the image pickup mobile 101 receives the video storage result reply signal transmitted in the step S410. In step S412, the image pickup mobile 101 judges whether the video storage process has succeeded or not based on the video storage result reply signal. If the video storage process is judged to have succeeded (S412: YES), the process proceeds to step S414, otherwise (S412: NO) the process proceeds to step S413. In the step S413, the user of the image pickup mobile 101 is informed of the failure of the video storage process by a video storage failure message displayed on the monitor of the image pickup mobile 101. In the step S414, the video storage process is ended.

Similarly, lines 415 drawn in FIG. 4 indicate boundaries separating the image pickup mobile 101, the video storage data converter 102 and the video storage/distribution device 1005.

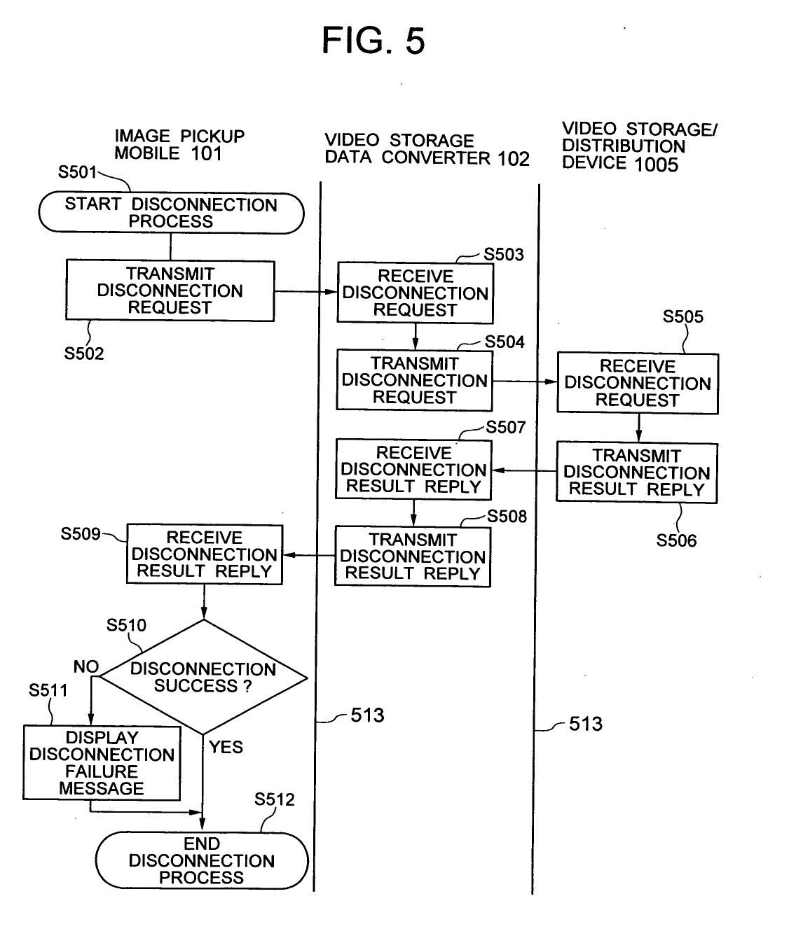

FIG. 5 is a flow chart showing the details of the step S204 of FIG. 2A for disconnecting the connection between the image pickup mobile 101 and the video storage/distribution device 1005.

In step S501, the disconnection process between the image pickup mobile 101 and the video storage/distribution device 1005 is started. In step S502, the image pickup mobile 101 transmits a disconnection request signal to the video storage data converter 102. In step S503, the video storage data converter 102 receives the disconnection request signal transmitted in the step S502. In step S504, the video storage data converter 102 converts the disconnection request signal into a signal of the protocol that can be interpreted by the video storage/distribution device 1005 and transmits the converted disconnection request signal. In step S505, the video storage/distribution device 1005 receives the disconnection request signal. In step S506, the video storage/distribution device 1005 transmits a disconnection result reply signal (indicating the result of the a process for the disconnection request signal) to the video storage data converter 102 and disconnects the connection with the video storage data converter 102. In step S507, the video storage data converter 102 receives the disconnection result reply signal. In step S508, the video storage data converter 102 converts the disconnection result reply signal into a signal of the protocol that can be interpreted by the image pickup mobile 101 and transmits the converted disconnection result reply signal. In step S509, the image pickup mobile 101 receives the disconnection result reply signal transmitted in the step S508. In step S510, the image pickup mobile 101 judges whether or not the disconnection process has succeeded based on the disconnection result reply signal. If the disconnection process is judged to have succeeded (S510: YES), the process proceeds to step S512, otherwise (S510: NO) the process proceeds to step S511. In the step S511, the user of the image pickup mobile 101 is informed of the failure of the disconnection process by a disconnection failure message displayed on the monitor 1109 of the image pickup mobile 101. In the step S512, the disconnection process is ended.

Similarly, the lines 513 drawn in FIG. 5 indicate boundaries separating the image pickup mobile 101, the video storage data converter 102 and the video storage/distribution device 1005.

By the above method, video data of the video images shot by the image pickup mobile 101 can be stored and accumulated in the video storage/distribution device 1005. The video data accumulated in the video storage/distribution device 1005 are thereafter distributed to the browser PC 1006 and mobile 1011 as needed.

When live image from an image pickup mobile 101 is being displayed by a browser PC 1006 or mobile 1011, the viewer might need or hope to instruct the user of the image pickup mobile 101 where to shoot. In order to meet such requests and realize voice communication, the data communicated among the browser PC 1006, video viewing data converter 1007, mobile 1011, video storage data converter 102 and image pickup mobile 101 have to include audio data in addition to the video data.

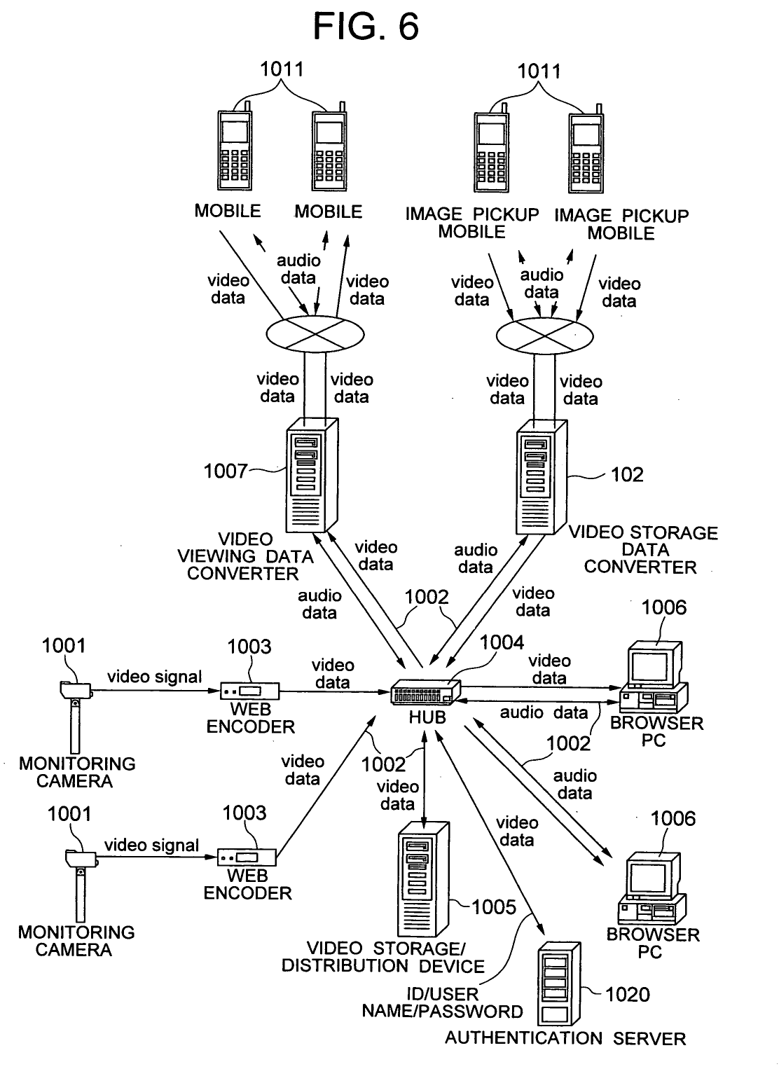

FIG. 6 is a block diagram showing an example of the structure of a network in accordance with the embodiment realizing the communication of audio data and data flow in the network. Differently from FIG. 1, FIG. 6 also shows the type of data transferred on each transmission line or link.

In the example of FIG. 6, the browser PC 1006, the mobile 1011 and the image pickup mobile 101 are capable of sending and receiving audio data. The audio data are distributed to each device through the hub 1004. The video viewing data converter 1007 and the video storage data converter 102 have the function for codec conversion and protocol conversion of audio data between the browser PC 1006 and the mobile (1011, 101).

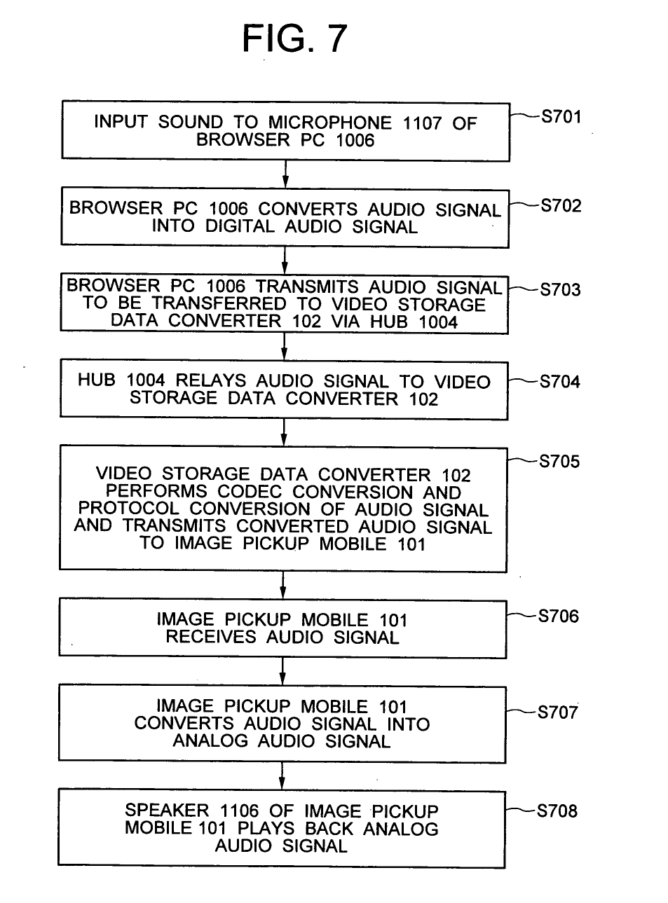

FIG. 7 is a flow chart explaining a case where audio data inputted to a browser PC 1006 is transmitted to an image pickup mobile 101.

In step S701, the microphone 1107 of the browser PC 1006 converts sound into an audio signal and outputs the audio signal. In step S702, the browser PC 1006 receives the audio signal from its microphone 1107 and generates a digital audio signal by performing A/D conversion such as PCM. In steps S703, the browser PC 1006 transmits the audio signal to be transferred to the video storage data converter 102 through the hub 1004 and the LAN transmission lines 1002. In step S704, the hub 1004 receives and transmits (relays) the audio signal to the video storage data converter 102 through the LAN transmission line 1002. The audio data may also be distributed to a browser PC 1006 other than the browser PC 1006 that transmitted the audio signal. In this case, the received audio signal is transmitted (relayed) to other browser PC 1006 as it is since the codec conversion and protocol conversion are unnecessary. In step S705, the video storage data converter 102 receives the audio signal from the hub 1004, converts the audio signal into a signal of a proper protocol and format that can be interpreted and played back by the image pickup mobile 101 by executing the codec conversion and protocol conversion, and transmits the converted audio signal to the image pickup mobile 101. When there are two or more image pickup mobiles 101 that should receive the audio signal, the audio signal is transmitted to each of them. In step S706, the image pickup mobile 101 receives the audio signal containing the audio data. In step S707, the image pickup mobile 101 converts the received audio signal into an analog audio signal by executing D/A conversion. In step S708, the analog audio signal is played back by the speaker 1106 of the image pickup mobile 101.

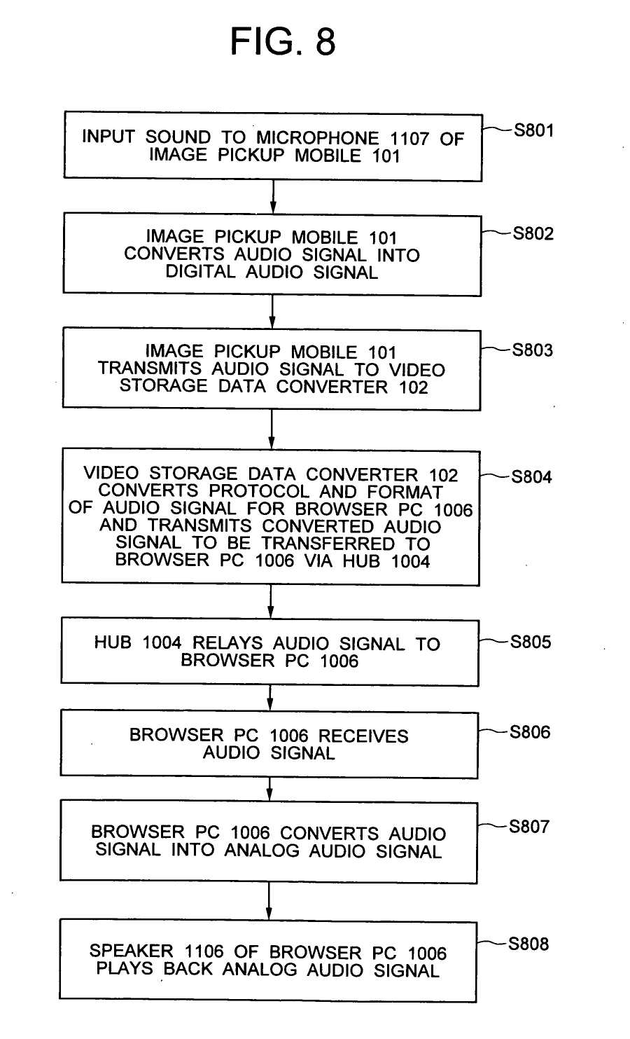

FIG. 8 is a flow chart explaining a case where an audio signal is transmitted from an image pickup mobile 101 to a browser PC 1006.

In step S801, the microphone 1107 of the image pickup mobile 101 converts sound into an audio signal and outputs the audio signal. In step S802, the image pickup mobile 101 converts the analog audio signal into a digital audio signal. In step S803, the image pickup mobile 101 transmits the audio signal to the video storage data converter 102. In step S804, the video storage data converter 102 receives the audio signal, converts the audio signal into a signal of a format and protocol that can be received and interpreted by the browser PC 1006, and transmits the converted audio signal to be transferred to the browser PC 1006 through the hub 1004. In step S805, the hub 1004 receives and transmits (relays) the audio signal to the browser PC 1006. When there are two or more browser PCs 1006 that receive the audio signal, the audio signal is transmitted to each of them. In step S806, the browser PC 1006 receives the audio signal. In step S807, the browser PC 1006 converts the audio signal into an analog audio signal by executing D/A conversion. In step S808, the analog audio signal is played back by the speaker 1106 of the browser PC 1006.

While the transmission of an audio signal from a browser PC 1006 to an image pickup mobile 101 and the transmission of an audio signal from an image pickup mobile 101 to a browser PC 1006 have been described above referring to FIGS. 7 and 8 as concrete examples, the processes of FIGS. 7 and 8 can also be applied to cases where a mobile 1011 transmits or receives an audio signal. In these cases, the audio signal may be transmitted to the video viewing data converter 1007 (not to the video storage data converter 102) in the step S704 of FIG. 7, and the step S705 may be executed by the video viewing data converter 1007. Similarly, the mobile 1011 may transmit the audio signal to the video viewing data converter 1007 (not to the video storage data converter 102) in the step S803 of FIG. 8, and the steps S804 and S805 may be executed by the video viewing data converter 1007.

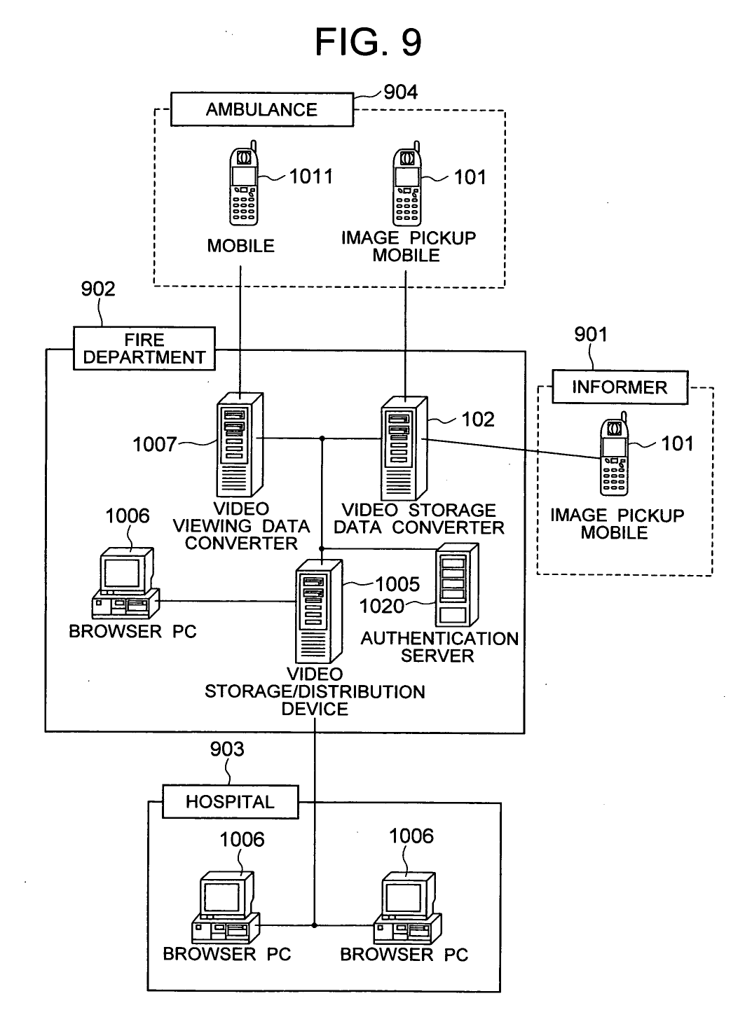

FIG. 9 is a block diagram showing an example of system configuration of an emergency medical care system employing the video storage techniques and voice communication techniques of the video data distribution system described above.

In FIG. 9, the reference numeral “901” denotes an informer, “902” denotes a fire department, “903” denotes a hospital, and “904” denotes an ambulance. The informer 901 carries an image pickup mobile 101. The fire department 902 is equipped with the video storage/distribution device 1005, the video viewing data converter 1007, the video storage data converter 102, the authentication server 1020, and a browser PC 1006. The hospital 903 is provided with a browser PC 1006. The ambulance 904 carries a mobile 1011 and an image pickup mobile 101. In the fire department 902, the video storage/distribution device 1005 is connected with the video storage data converter 102, the video viewing data converter 1007, the authentication server 1020 and the browser PC 1006 through a LAN. The video storage/distribution device 1005 of the fire department 902 is also connected to the browser PC 1006 of the hospital 903 through the LAN and a public circuit.

In the following, a process for carrying an emergency patient found by the informer 901 to the hospital 903 by the ambulance 904 in the above system configuration will be described. First, the informer 901 requests an ambulance 904 from the fire department 902. In this case, the informer 901 informs the fire department 902 of the emergency patient by use of the image pickup mobile 101. The informer 901 shoots and records the condition of the emergency patient with the image pickup mobile 101 and sends a video signal containing video images of the patient to the fire department 902. The video signal is transferred to the browser PC 1006 of the fire department 902 and the browser PC 1006 of the hospital 903 through the video storage data converter 102 and the video storage/distribution device 1005 of the fire department 902, by which video images of the patient become available at the fire department 902 and the hospital 903. At the hospital, doctors consider and discuss proper treatment for the patient, seeing the video images displayed on the monitor 1109 of the browser PC 1006. When a doctor records a voice message through the microphone 1107 of the browser PC 1006, an audio signal containing the voice message is delivered to the image pickup mobile 101 (informer 901) by the process of FIG. 7, by which the doctor can vocally instruct the informer 901 about the direction of the image pickup mobile 101, first aid treatment, etc. Also attendants of the ambulance 904 rushing to the scene can view the video images displayed on the mobile 1011 of the ambulance 904, by which treatment suitable for the condition of the patient can be considered previously.

After the ambulance 904 arrives at the scene, video images of the patient, shot by the image pickup mobile 101 of the ambulance 904 or the informer 901, are continuously transmitted to the browser PC 1006 of the hospital 903 through the fire department 902, by which the doctors at the hospital 903 can continuously check the condition of the patient in the ambulance 904 and give vocal instructions to the ambulance attendants. Necessary first aid treatment and preparation of instruments, medicines, etc. have already been finished at the stage when the ambulance 904 with the patient arrives at the hospital 903, by which intensive and effective treatment can be started immediately. Further, the video data of the patient being carried to the hospital 903, which have been successively stored in the video storage/distribution device 1005, can be played back at any time, therefore, the doctors are allowed to judge the patient's condition correctly by watching video images of the past as needed. By the process described above, the doctors at the hospital 903 are allowed to obtain video (image) information of the patient to be carried to the hospital 903 in addition to the conventional audio information, by which prompter and more accurate treatment can be given to the patient.

While the system connecting a fire department, ambulance, hospital and informer has been described above as an example of application of the networked monitoring system of the first embodiment, similar systems can also be built up for other public offices (e.g. police stations, fire departments), municipalities (e.g. municipal offices), mass media companies (e.g. TV stations, newspaper publishing companies), etc. For municipalities, the above system can be used, for example, for monitoring and reporting accidents or abnormalities of dams, power plants, etc. Mass media companies may employ the above system for collecting the first video reports from ordinary people having an image pickup mobile. Police stations can use the above system for gathering video information from citizens for early resolution of cases. Since the above system can deliver video data and audio data from a distant place to a plurality of devices, a television conference system uniting people at distant places can be realized using the video data and audio data transmitted by the image pickup mobile. Further, since the video data from the image pickup mobile 101 is successively stored in the video storage/distribution device 1005, the video data can be accumulated and presented as a video message board or a video library. The video message board and/or video library can be provided to, for example, a public hall, community center, etc. for information exchange among local residents.

By the first embodiment described above, targets (scenes, objects, individuals, etc.) can be shot easily and their video data can be obtained even at places where no monitoring camera is installed or even when the targets are at dead angles (blind spots) of a monitoring camera, and the obtained video data can be accumulated and distributed to a plurality of devices at distant places together with audio data.

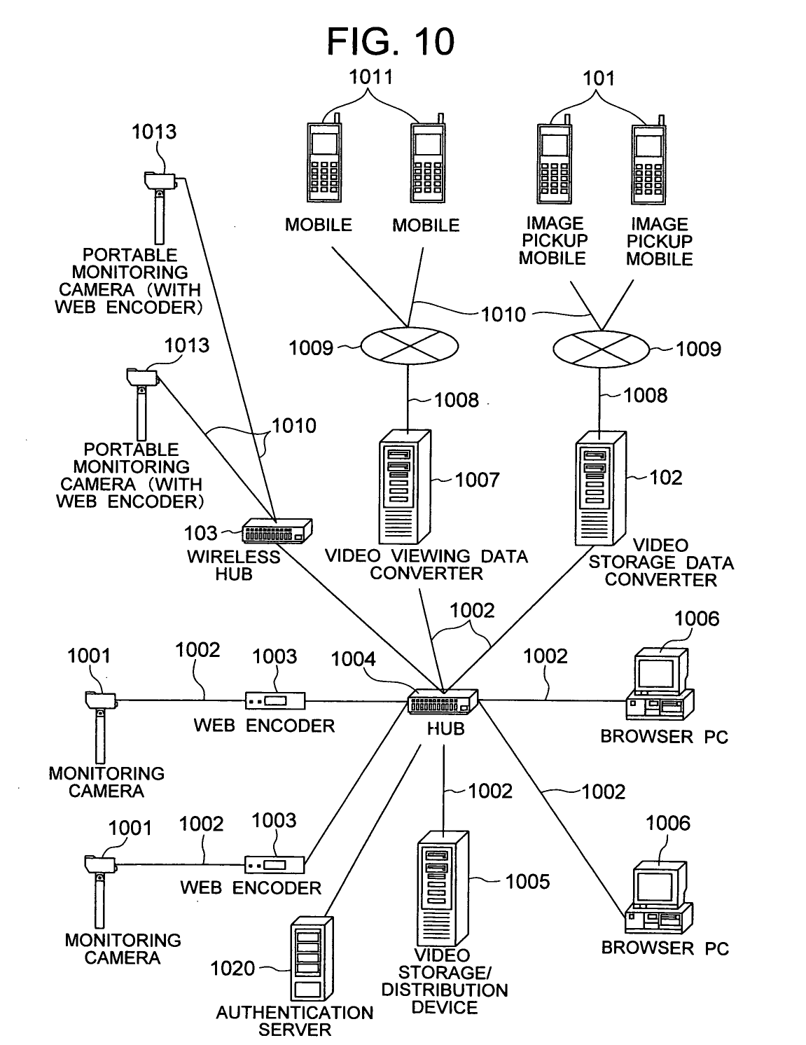

FIGS. 10 through 16 show a networked monitoring system (network) as a video data distribution system in accordance with a second embodiment of the present invention.

FIG. 10 is a block diagram showing the structure of the network as the video data distribution system of the second embodiment. The network of FIG. 10 further includes portable monitoring camera 1013, radio transmission links 1010 and a wireless hub 103 in comparison with the network of FIG. 1.

In the network of FIG. 10, the portable monitoring camera 1013 are connected to the wireless hub 103 through the radio transmission links 1010. The wireless hub 103 is connected to the hub 1004 of the networked monitoring system through the LAN transmission lines 1002. Incidentally, each portable monitoring camera 1013 is equipped with a built-in Web encoder.

In the first embodiment of FIG. 1, data communication between a mobile and a server (video storage/distribution device 1005, etc.) was started after the authentication server 1020 has completed the authentication of the mobile, for realizing data communicate with an authenticated mobile only. Meanwhile, the authentication process by the authentication server 1020 can be omitted when data is communicated between a portable monitoring camera 1013 and a server (video storage/distribution device 1005, etc.) in the embodiment of FIG. 10. Since the portable monitoring camera 1013 are within the same LAN as the servers, communication management of the portable monitoring camera 1013 can be done more easily than that of the mobile (mobile 1011, image pickup mobile 101) out of the LAN without the need of using the authentication server 1020.

FIG. 11 is a block diagram showing an example of hardware configuration of the portable monitoring camera 1013 employed in the system of the second embodiment.

The portable monitoring camera 1013 shown in FIG. 11 includes a camera unit 3001, a Web encoder unit 3002, a microphone 3003, an A/D converter unit 3004, an audio encoder unit 3005, a speaker 3006, a D/A converter unit 3007, an audio decoder unit 3008, a radio unit 3009 and a bus 3010. The components 3001-3009 are connected together by the bus 3010. The radio unit 3009 is capable of communicating data with the wireless hub 103 through the radio transmission link 1010. The camera unit 3001, having a function equivalent to that of the conventional monitoring camera 1001, shoots the scene in front of the portable monitoring camera 1013 and outputs a video signal. The Web encoder unit 3002, having a function equivalent to that of the conventional Web encoder 1003, converts the video signal into a digital video signal. The microphone 3003 picks up sound and converts the sound into an audio signal. The A/D converter unit 3004 converts the analog audio signal from the microphone 3003 into a digital audio signal. The audio encoder unit 3005 converts the digital audio signal into an audio signal of a format that can be communicated among the browser PC 1006, video viewing data converter 1007 and the video storage data converter 102. The audio decoder unit 3008 converts an audio signal of the format that can be communicated among the browser PC 1006, video viewing data converter 1007 and the video storage data converter 102 into a digital audio signal that can be processed and converted by the D/A converter unit 3007. The D/A converter unit 3007 converts the digital audio signal into an analog audio signal. The speaker 3006 outputs sound corresponding to the analog audio signals. The radio unit 3009 communicates video signals and audio signals with the wireless hub 103 through the radio transmission link 1010.

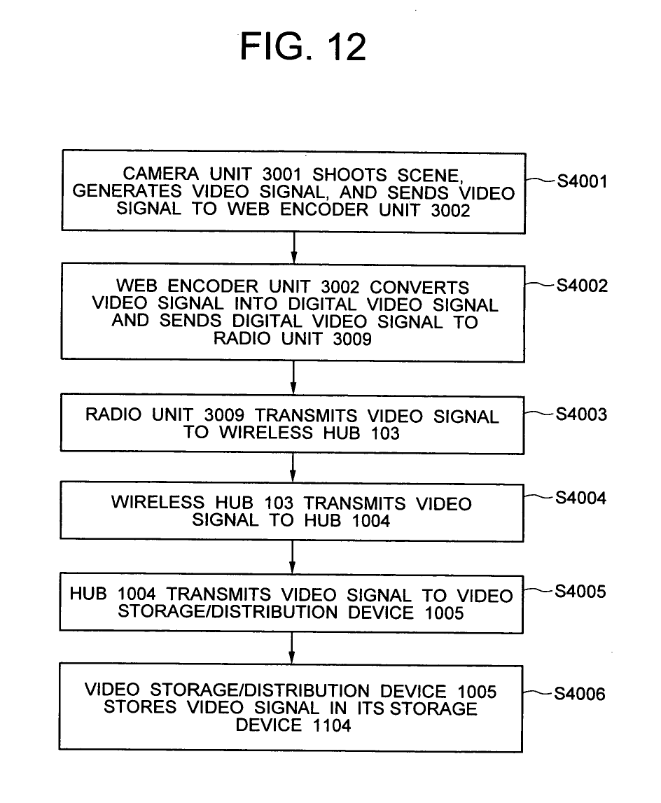

FIG. 12 is a flow chart showing a process for storing video data in the video storage/distribution device 1005 of the system of FIG. 10.

In step S4001, the camera unit 3001 of the portable monitoring camera 1013 shoots the scene, generates a video signal, and sends the video signal to the Web encoder unit 3002. In step S4002, the Web encoder unit 3002 converts the video signal into a digital video signal and sends the digital video signal to the radio unit 3009. In step S4003, the radio unit 3009 receives the video signal and transmits the video signal to the wireless hub 103. In step S4004, the wireless hub 103 receives the video signal and transmits the video signal to the hub 1004. In step S4005, the hub 1004 receives the video signal and transmits the video signal to the video storage/distribution device 1005. In step S4006, the video storage/distribution device 1005 receives the video signal and stores the video signal in its storage device 1104 as video data.

By the above process, video data of the scene shot by the portable monitoring camera 1013 can be stored and accumulated in the video storage/distribution device 1005.

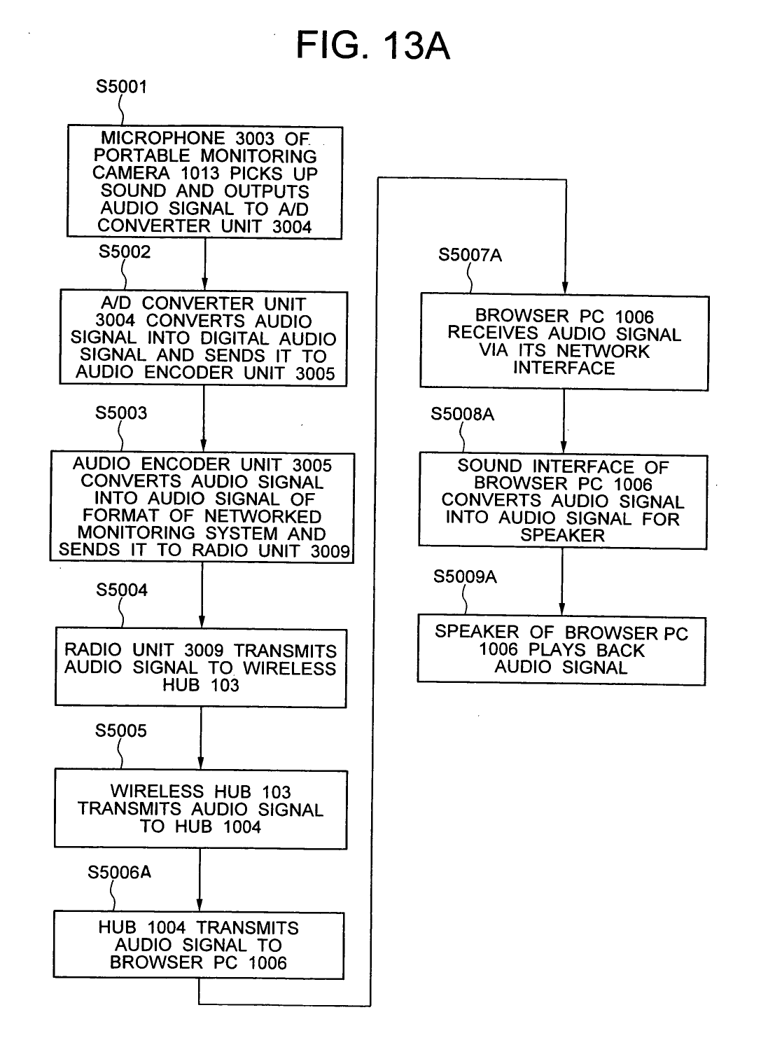

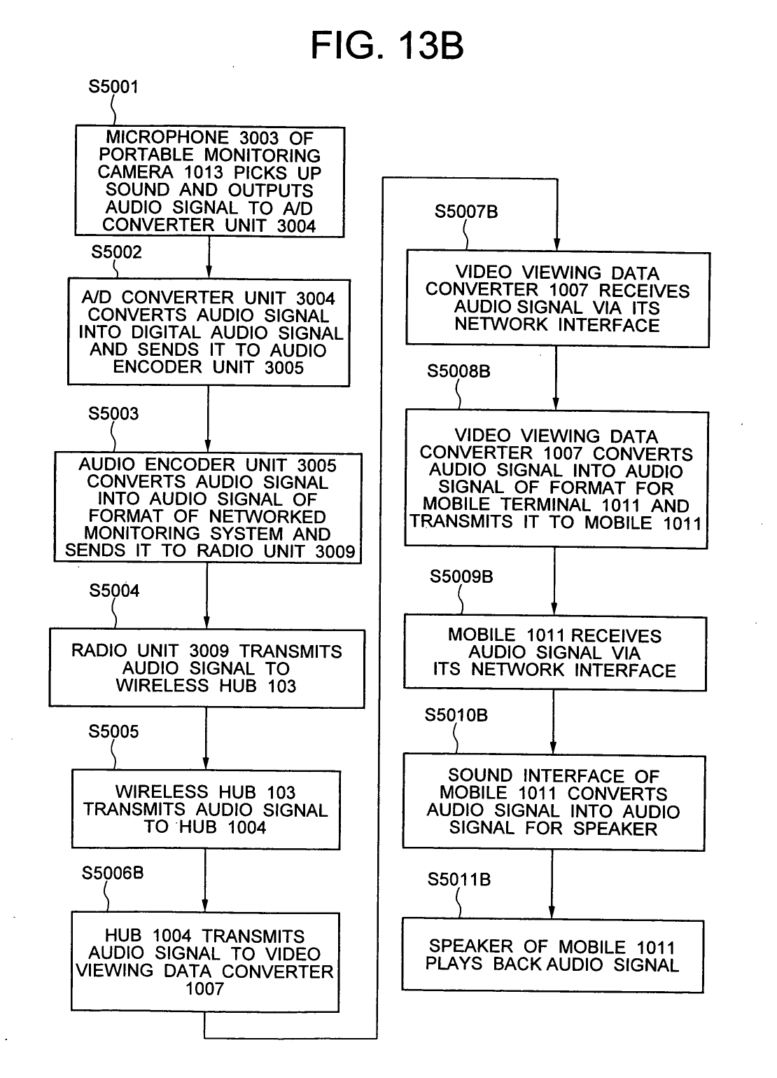

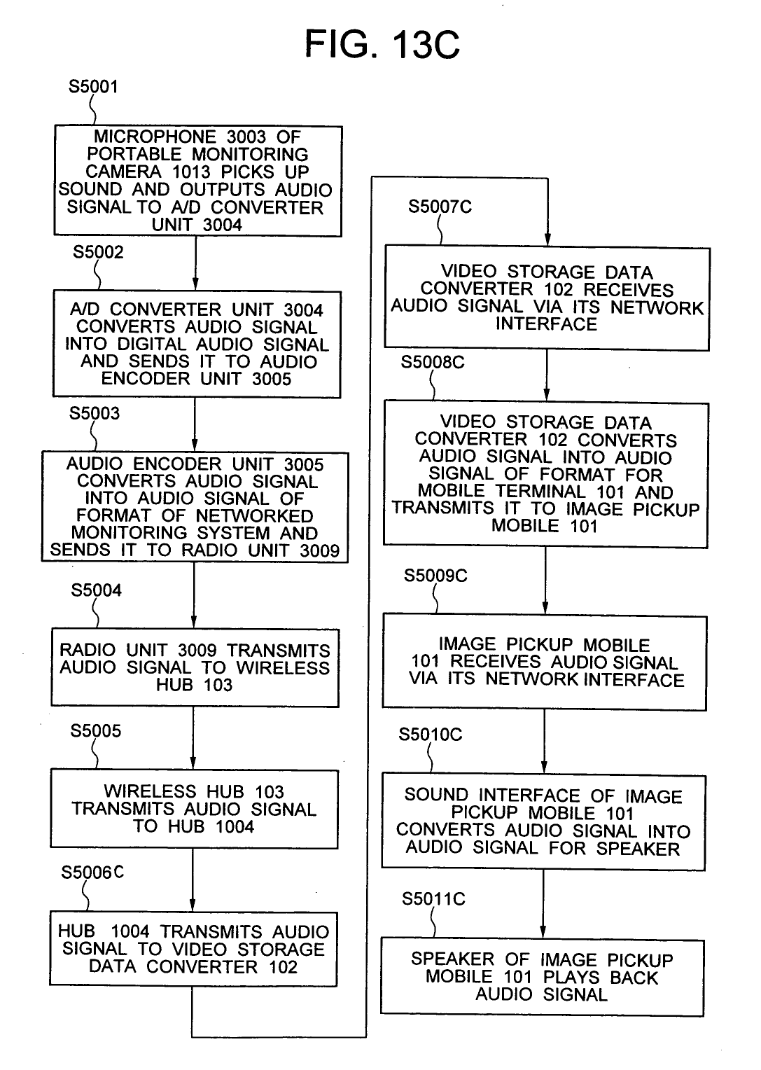

FIG. 13A is a flow chart showing a process for distributing audio data of sound picked up by the portable monitoring camera 1013 to the browser PC 1006, the mobile 1011 and the image pickup mobile 101.

In step S5001, the microphone 3003 of the portable monitoring camera 1013 picks up sound and outputs an audio signal to the A/D converter unit 3004. In step S5002, the A/D converter unit 3004 receives the audio signal, converts the analog audio signal into a digital audio signal, and sends the converted audio signal to the audio encoder unit 3005. In step S5003, the audio encoder unit 3005 converts the format of the audio signal into a format that can be received by the browser PC 1006, the video viewing data converter 1007 and the video storage data converter 102 (that is, into the format handled inside the networked monitoring system), and sends the converted audio signal to the radio unit 3009. In step S5004, the radio unit 3009 receives the audio signal and transmits the audio signal to the wireless hub 103. In step S5005, the wireless hub 103 receives the audio signal and transmits the audio signal to the hub 1004. In step S5006A, the hub 1004 receives the audio signal and transmits the audio signal to the browser PC 1006. In step S5007A, the browser PC 1006 receives the audio signal through its network interface 1103. In step S5008A, the sound interface 1105 of the browser PC 1006 converts the format of the received audio signal into a format for the playback by the speaker 1106. In step S5009A, the speaker 1106 of the browser PC 1006 plays back the converted audio signal.

By the process described above, audio data of sound picked up by the portable monitoring camera 1013 can be distributed to the browser PC 1006.

FIG. 13B is a flow chart showing a process for distributing audio data of sound picked up by the portable monitoring camera 1013 to the mobile 1011. Here, Steps S5001-5005 in FIG. 13B are same as the steps S5001-5005 in FIG. 13A. So, the explanation from the next step of Step 5005 will be described.

In step S5006B, the hub 1004 receives the audio signal and transmits the audio signal to video viewing data converter 1007.

In step S5007B, the video viewing data converter 1007 receives the audio signal through its network interface 1103. In step S5008B, the video viewing data converter 1007 converts the format of the received audio signal into a format that can be received by a mobile 1011 (as the destination) and transmits the converted audio signal to the mobile 1011. In step S5009B, the mobile 1011 receives the audio signal through its network interface 1103. In step S5010B, the sound interface 1105 of the mobile 1011 converts the format of the received audio signal into a format for the playback by the speaker 1106. In step S5011B, the speaker 1106 of the mobile 1011 plays back the converted audio signal.

By the process described above, audio data of sound picked up by the portable monitoring camera 1013 can be distributed to the mobile 1011.

FIG. 13C is a flow chart showing a process for distributing audio data of sound picked up by the portable monitoring camera 1013 to the image pickup mobile 101. Here, Steps S5001-5005 in FIG. 13C are same as the steps S5001-5005 in FIGS. 13A and 13B. So, the explanation from the next step of Step 5005 will be described.

In step S5007C, the video storage data converter 102 receives the audio signal through its network interface 1103. In step S5008C, the video storage data converter 102 converts the format of the received audio signal into a format that can be received by an image pickup mobile 101 (as the destination) and transmits the converted audio signal to the image pickup mobile 101. In step S5009C, the image pickup mobile 101 receives the audio signal through its network interface 1103. In step S5010C, the sound interface 1105 of the image pickup mobile 101 converts the format of the received audio signal into a format for the playback by the speaker 1106. In step S5011C, the speaker 1106 of the image pickup mobile 101 plays back the converted audio signal.

By the process described above, audio data of sound picked up by the portable monitoring camera 1013 can be distributed to the image pickup mobile 101.

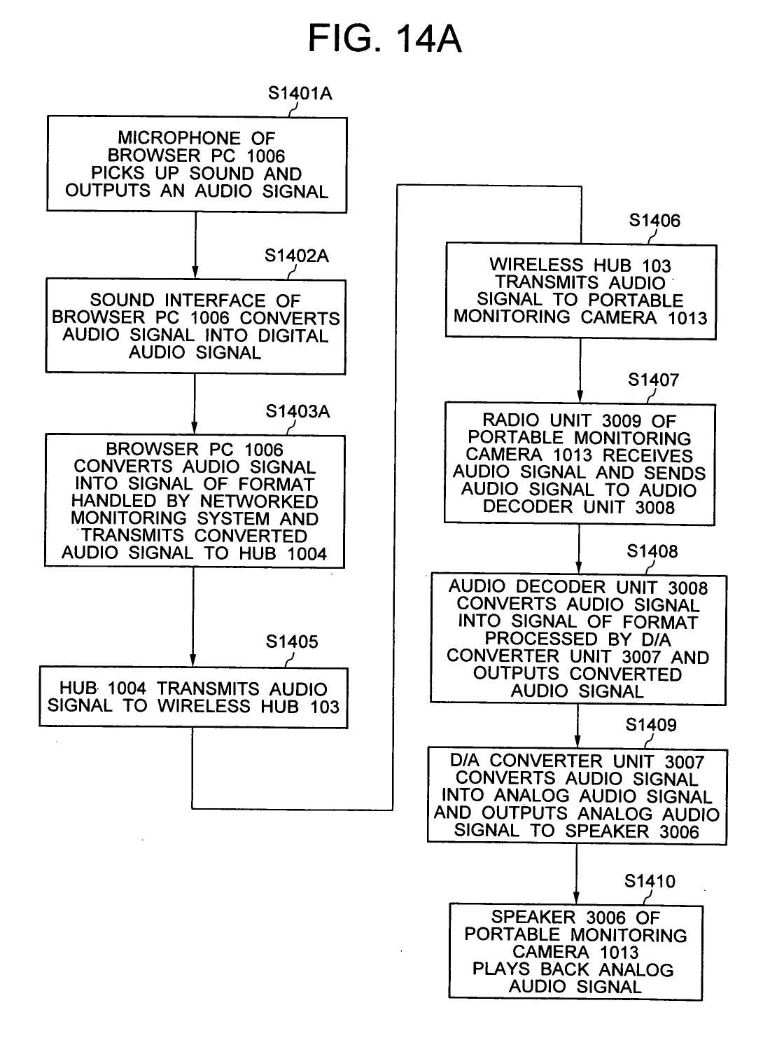

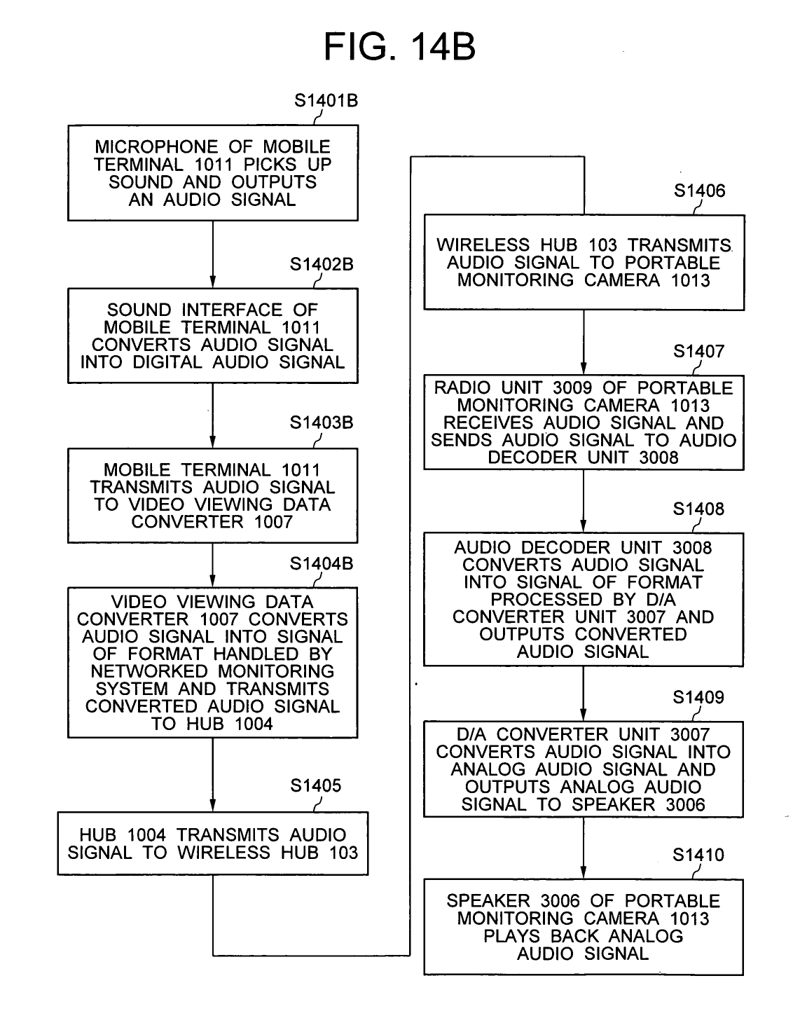

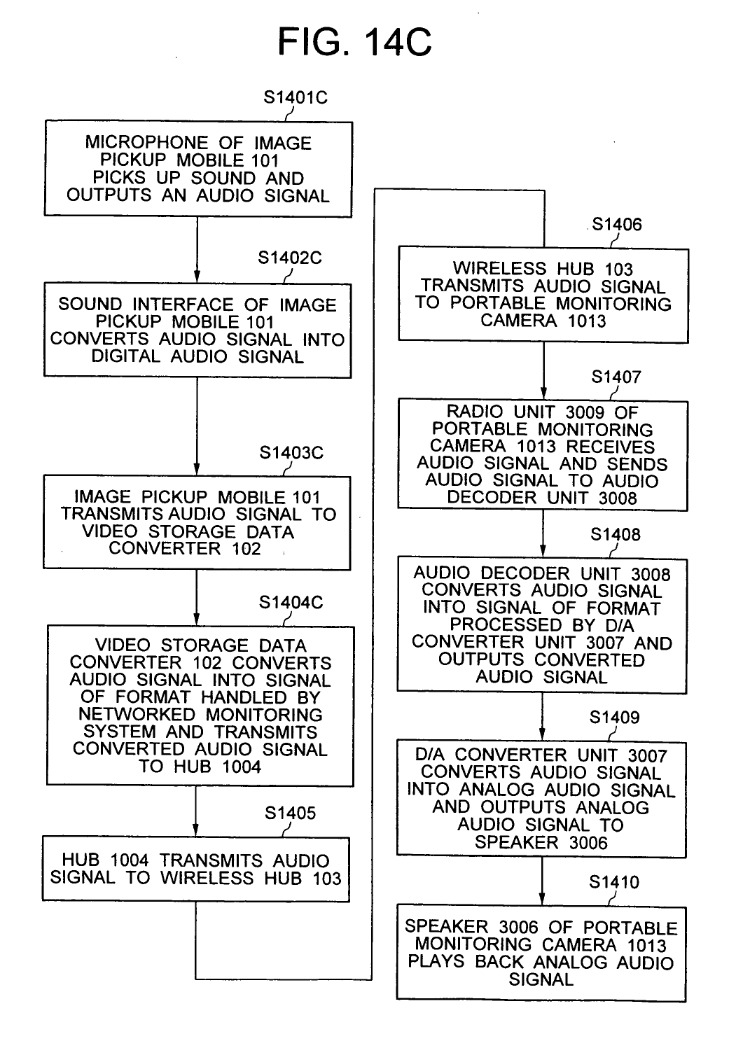

FIG. 14A is a flow chart showing a process for transmitting audio data of sound picked up by a browser PC 1006 to a portable monitoring camera 1013 and playing back the audio data by the terminal portable monitoring camera 1013.

In step S1401A, the microphone of a browser PC 1006 picks up sound and outputs an audio signal. In step S1402A, the sound interface of the browser PC 1006 converts the audio signal into a digital audio signal. The branching is necessary for handling the audio signal inside the networked monitoring system uniformly, since the browser PC 1006 handles audio signals of different codec types and protocols. In step S1403A, the browser PC 1006 converts the format of the digital audio signal into the format handled inside the networked monitoring system and transmits the converted audio signal to the hub 1004.

In the step S1405, the hub 1004 receives the audio signal from the browser PC 1006 and transmits the audio signal to the wireless hub 103. In step S1406, the wireless hub 103 receives the audio signal and transmits the audio signal to the portable monitoring camera 1013. In step S1407, the radio unit 3009 of the portable monitoring camera 1013 receives the audio signal and sends the audio signal to the audio decoder unit 3008. In step S1408, the audio decoder unit 3008 converts the format of the audio signal into a format that can be processed by the D/A converter unit 3007, and outputs the converted audio signal to the D/A converter unit 3007. In step S1409, the D/A converter unit 3007 converts the audio signal into an analog audio signal and outputs the analog audio signal to the speaker 3006. In step S1410, the analog audio signal is played back by the speaker 3006 of the portable monitoring camera 1013.

By the above process, sound picked up by a browser PC 1006 can be played back by a portable monitoring camera 1013.

FIG. 14B is a flow chart showing a process for transmitting audio data of sound picked up by a mobile 1011 to a portable monitoring camera 1013 and playing back the audio data by the terminal portable monitoring camera 1013.

In step S1401B, the microphone of a mobile 1011 picks up sound and outputs an audio signal. In step S1402B, the sound interface of the mobile 1011 converts the audio signal into a digital audio signal. In step S1403B, the mobile 1011 transmits the digital audio signal to the video viewing data converter 1007. In step S1404B, the video viewing data converter 1007 receives the audio signal, converts the format of the received audio signal into a format that can be received by the portable monitoring camera 1013 (that is, into the format handled inside the networked monitoring system), and transmits the converted audio signal to the hub 1004.

In the step S1405, the hub 1004 receives the audio signal from the mobile 1011, and transmits the audio signal to the wireless hub 103. In step S1406, the wireless hub 103 receives the audio signal and transmits the audio signal to the portable monitoring camera 1013. In step S1407, the radio unit 3009 of the portable monitoring camera 1013 receives the audio signal and sends the audio signal to the audio decoder unit 3008. In step S1408, the audio decoder unit 3008 converts the format of the audio signal into a format that can be processed by the D/A converter unit 3007, and outputs the converted audio signal to the D/A converter unit 3007. In step S1409, the D/A converter unit 3007 converts the audio signal into an analog audio signal and outputs the analog audio signal to the speaker 3006. In step S1414, the analog audio signal is played back by the speaker 3006 of the portable monitoring camera 1013.

By the above process, sound picked up by a mobile 1011 can be played back by a portable monitoring camera 1013.

FIG. 14C is a flow chart showing a process for transmitting audio data of sound picked up by an image pickup mobile 101 to a portable monitoring camera 1013 and playing back the audio data by the terminal portable monitoring camera 1013′.

In step S1401, the microphone 1107 of a browser PC 1006, mobile 1011 or image pickup mobile 101 picks up sound and outputs an audio signal. In step S1402, the sound interface 1105 of the browser PC 1006, mobile 1011 or image pickup mobile 101 converts the audio signal into a digital audio signal. In step S1403C, the image pickup mobile 101 transmits the digital audio signal to the video storage data converter 102. In step S1404C, the video storage data converter 102 receives the audio signal, converts the format of the received audio signal into the format that can be received by the portable monitoring camera 1013 (that is, into the format handled inside the networked monitoring system), and transmits the converted audio signal to the hub 1004.

In the step S1405, the hub 1004 receives the audio signal from the image pickup mobile 101, and transmits the audio signal to the wireless hub 103. In step S1406, the wireless hub 103 receives the audio signal and transmits the audio signal to the portable monitoring camera 1013. In step S1407, the radio unit 3009 of the portable monitoring camera 1013 receives the audio signal and sends the audio signal to the audio decoder unit 3008. In step S1408, the audio decoder unit 3008 converts the format of the audio signal into a format that can be processed by the D/A converter unit 3007, and outputs the converted audio signal to the D/A converter unit 3007. In step S1409, the D/A converter unit 3007 converts the audio signal into an analog audio signal and outputs the analog audio signal to the speaker 3006. In step S1410, the analog audio signal is played back by the speaker 3006 of the portable monitoring camera 1013.

By the above process, sound picked up by an image pickup mobile 101 can be played back by a portable monitoring camera 1013.

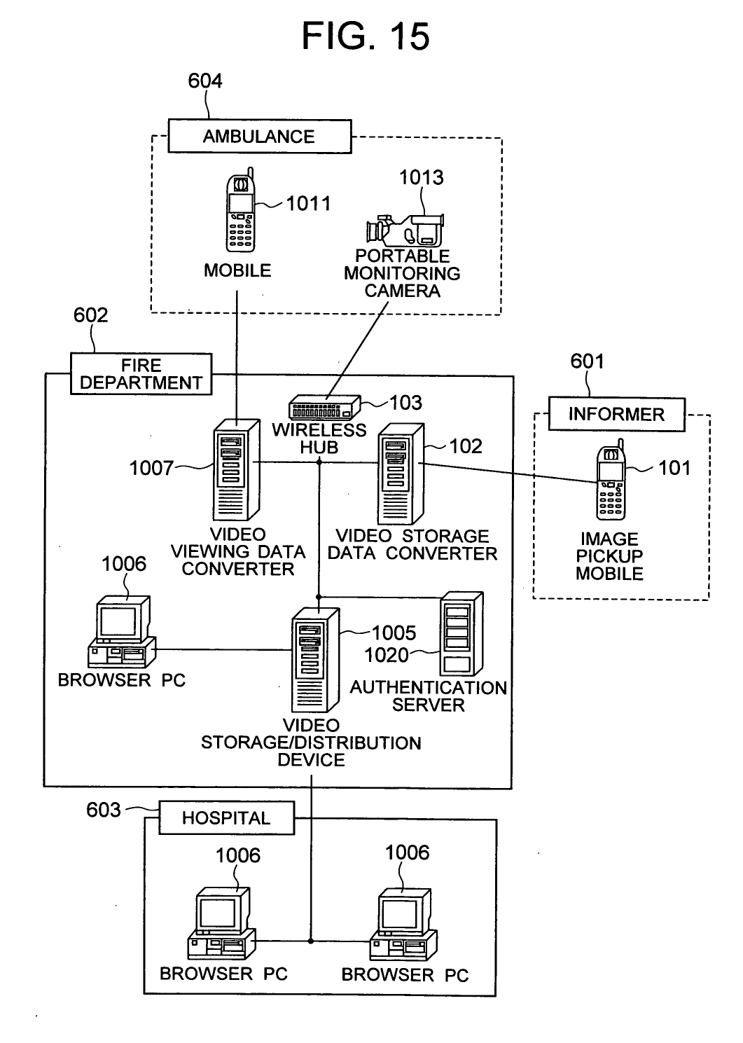

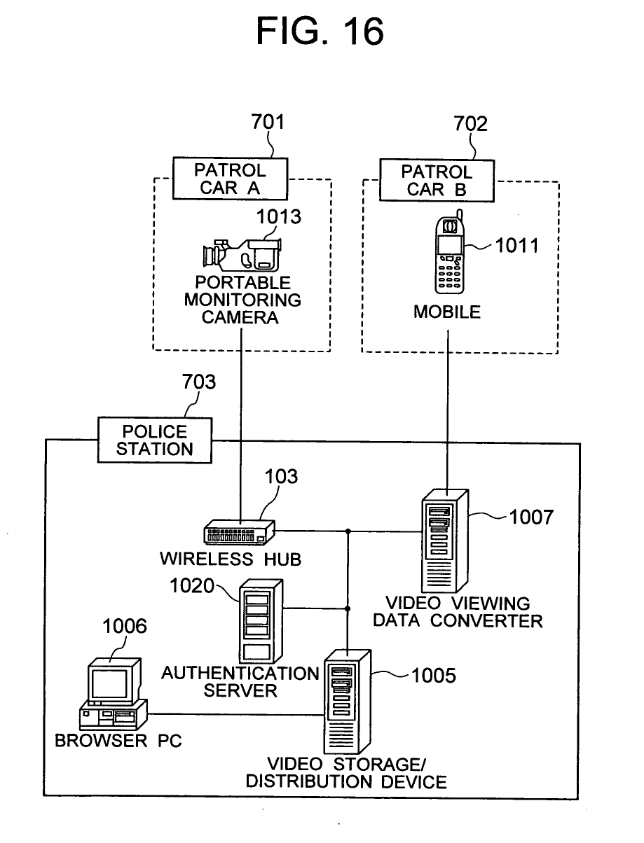

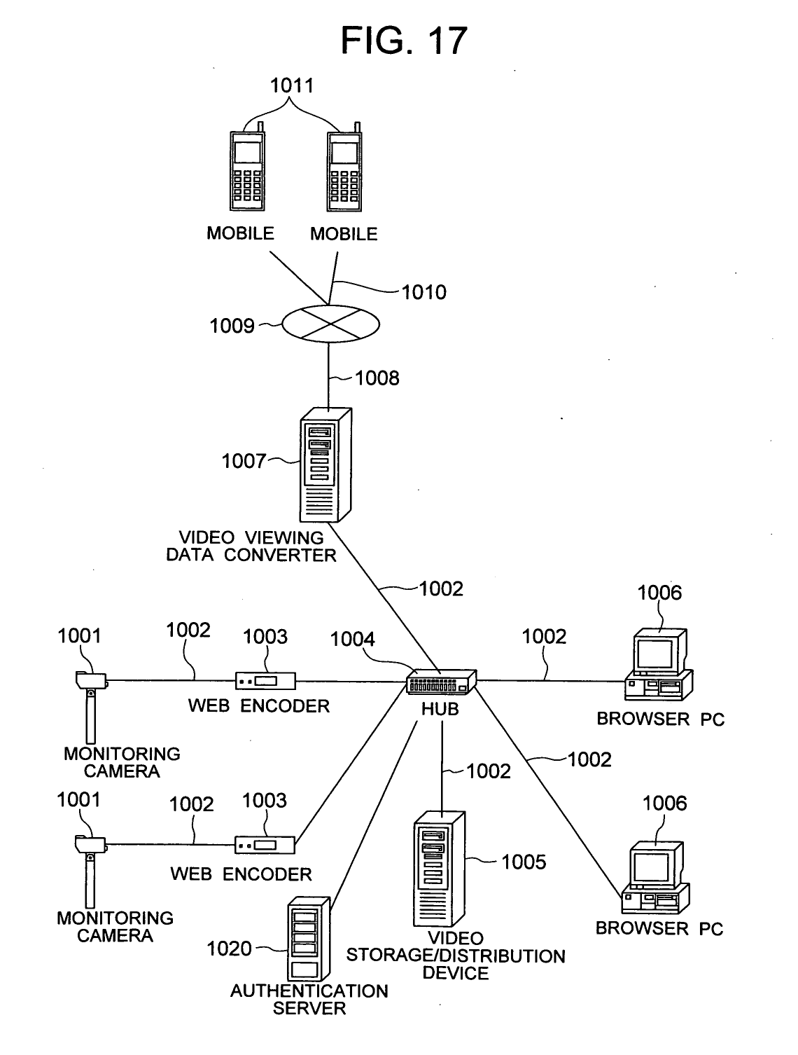

FIGS. 15 and 16 are block diagrams showing examples of application of the networked monitoring system of the second embodiment employing the portable monitoring camera 1013.

FIG. 15 shows an example of application of the networked monitoring system to a fire department. The system of FIG. 15 in accordance with the second embodiment of the present invention can be put in contrast with the emergency medical care system of FIG. 9 according to the first embodiment. In the system of FIG. 15, the reference numeral “601” denotes an informer 601, “602” denotes a fire department, “603” denotes a hospital, and “604” denotes an ambulance. The informer 601 carries an image pickup mobile 101. The fire department 602 is equipped with the networked monitoring system including the wireless hub 103, the video viewing data converter 1007, the video storage data converter 102, the video storage/distribution device 1005, the authentication server 1020 and a browser PC 1006. The hospital 603 is provided with a browser PC 1006. The browser PC 1006 of the hospital 603 are connected to the networked monitoring system of the fire department 602 through a LAN and a public circuit. The ambulance 604 carries a mobile 1011 and a portable monitoring camera 1013. The mobile 1011 and the portable monitoring camera 1013 of the ambulance 604 are connected to the networked monitoring system of the fire department 602 through radio transmission links, LAN and public circuit.

In the above system configuration, when the informer 601 finds an emergency patient, the informer 601 requests an ambulance 604 from the fire department 602 by use of the image pickup mobile 101, while shooting and recording the condition of the emergency patient with the image pickup mobile 101 and sending a video signal containing video images of the patient to the networked monitoring system of the fire department 602. By this, the video images of the patient become available at the browser PC 1006 of the fire department 602, the browser PC 1006 of the hospital 603, and the mobile 1011 of the ambulance 604. Meanwhile, the video signal is successively stored and accumulated in the video storage/distribution device 1005. At the hospital 603, doctors can determine emergency treatment necessary for the patient based on the video images displayed on the browser PC 1006 and give vocal instructs to the informer 601 about first aid treatment, the direction of the image pickup mobile 101, etc., by which proper first-aid measures can be taken and proper video images desired by the doctors can be collected. The video image of the patient is also displayed on the mobile 1011 of the ambulance 604 rushing to the scene, by which the ambulance attendants can quickly determine necessary measures to be taken.

After the ambulance 604 arrives at the scene and the patient is picked up, the condition of the patient being carried to the hospital 603 can be recorded by use of the portable monitoring camera 1013 and a video signal obtained by the portable monitoring camera 1013 can be transmitted to the hospital 603. Video images obtained from the video signal supplied from the portable monitoring camera 1013 has higher image quality than those obtained from the video signal supplied from the image pickup mobile 101, by which the doctors are allowed to make a more precise and proper judgment on the emergency treatment based on the high quality images. The doctors can also give vocal instructions to the ambulance attendant handling the portable monitoring camera 1013. The video images of the patient successively stored in the video storage/distribution device 1005 can also be played back during the treatment to the patient, by which the doctors are allowed to grasp the change of the patient's condition and take necessary measures more suitably and efficiently.

By the above system, the doctors at the hospital 903 can obtain the high quality video information (shot by the portable monitoring camera 1013) of the patient to be carried to the hospital 903 in addition to audio information, by which still more accurate and prompter treatment to the patient is realized.

FIG. 16 shows an example of application of the networked monitoring system of the second embodiment to a police station. In the system of FIG. 16, the reference numerals “701” and “702” denote patrol cars and “703” denotes the police station. The patrol car 701 carries a portable monitoring camera 1013 while the patrol car 702 carries a mobile 1011. The police station 703 is equipped with the networked monitoring system. When the patrol car 701 is in pursuit of a car, an officer on the patrol car 701 shoots video images of the car with the portable monitoring camera 1013. A video signal containing the video images is transmitted to the networked monitoring system of the police station 703. In the police station 703, video images according to the video signal from the patrol car 701 can be viewed on the browser PC 1006.

The video images contain information such as the type of car, the license plate number, etc., by which information such as the owner of the car can be identified quickly. When the patrol car 701 calls for backup of the patrol car 702, the officer on the patrol car 701 can give vocal instructions or video information about the current location, etc. to the patrol car 702 through the portable monitoring camera 1013 and the mobile 1011. By the video signal supplied from the networked monitoring system of the police station 703 to the mobile 1011 of the patrol car 702, officers on the patrol car 702 can learn the type, color, etc. of the car beforehand, allowing them to recognize the car easily on arrival at the scene. Further, the video data accumulated in the video storage/distribution device 1005 of the police station 703 can be saved and used later as critical evidence of traffic violations.

By the above system, the police station 703 is allowed to carry out pursuits of offenders etc. more promptly and accurately. Video images of pursuit, incidents, etc. can be stored in the video storage/distribution device 1005 and can be used later as evidence.

While examples of application of the networked monitoring system of the second embodiment to a fire department and a police station have been described above, similar systems can also be built up for municipalities, mass media companies, etc. Since the audio/video data from the portable monitoring camera 1013 is distributed to the browser PC 1006, mobile 1011 and image pickup mobile 101, it is possible to realize a television conference system, etc. by use of the video images shot by the portable monitoring camera 1013.

Also by the second embodiment of the present invention, targets (scenes, objects, individuals, etc.) can be shot easily and their video data can be obtained even at places where no monitoring camera is installed or even when the targets are at dead angles of a monitoring camera, and the obtained video data can be accumulated and distributed to a plurality of devices at distant places together with audio data. Further, by use of the portable monitoring camera 1013 having higher image quality than image pickup mobile 101, video information of higher quality or definition can be collected and utilized. Prompt, correct and proper use of information flexibly gathered from wide range of places becomes possible.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A video data distribution system for distributing video data through a network, comprising:
a mobile equipment including at least one image pickup mobile with an image pickup device for generating and transmitting video data;
an authentication server unit having an authentication table for authenticating said image pickup mobile;
a data converter for converting the video data generated by said image pickup mobile into a video data of predetermined type for storing;
a video storage/distribution device for storing said video data of said predetermined type transmitted from said mobile equipment authorized by the authorization table; and
wherein said video data of said predetermined type stored in the video storage/distribution device is distributed to said mobile equipment based on a distribution request from said mobile equipment.

2. A video data distribution system according to claim 1,
wherein said mobile equipment comprises an image pick-up device and said image pickup mobile.

3. A video data distribution system according to claim 2,
wherein at least an ID number in said image pickup mobile is registered in the authentication table; and
wherein video data from said image pickup mobile corresponding to the ID number is stored in the video storage/distribution device.

4. A video data distribution system according to claim 1,
wherein when video data stored in said video storage/distribution device is distributed to said mobile equipment based on a distribution request from said mobile equipment, the video storage/distribution device confirms whether or not the mobile equipment which sent the distribution request is registered in the authentication table and distributes the video data if the mobile equipment is registered.

5. A video data distribution method for distributing video data through a network, a mobile equipment including at least one image pickup mobile with an image pickup device, said method comprising the steps of:
generating and transmitting video data by said mobile equipment;
authenticating the image pickup mobile of said mobile equipment by using of an authentication table;
converting the video data generated by said image pickup mobile into a video data of predetermined type for storing;
storing said video data of said predetermined type transmitted from the authorized image pickup mobile; and
distributing said video data of said predetermined type to said mobile equipment based on a distribution request from said mobile equipment.
